(19) United States
(12) Patent Application Publication
(10) Pub. No.: US 2026/0291924 A1
(43) Pub. Date: Sep. 24, 2026

(54) SYSTEM

(71) Applicant: SoftBank Group Corp., Tokyo (JP)

(72) Inventor: Masashi WATANABE, Tokyo (JP)

(73) Assignee: SoftBank Group Corp., Tokyo (JP)

(21) Appl. No.: 19/567,373

(22) Filed: Mar. 16, 2026

(30) Foreign Application Priority Data
Mar. 19, 2025 (JP) 2025-045276

(51) Int. Cl. H04L 9/40; G06F 40/186; G06F 40/284; G06F 40/289; G06N 3/0475; H04L 9/08

(52) U.S. Cl. CPC H04L 63/0435; G06F 40/289; G06N 3/0475; H04L 9/0819; H04L 63/105; G06F 40/186; G06F 40/284

(57) ABSTRACT

A system includes a processor that is configured to receive genetic information from a user, generate a prompt for a generative artificial intelligence model in order to analyze the received genetic information, generate information based on a result obtained from the generative artificial intelligence model using the generated prompt, and provide the generated information to the user.

### CROSS-REFERENCE TO RELATED APPLICATION

This application is based on and claims priority under 35 USC 119 from Japanese Patent Application No. 2025-045276 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for providing information based on genetic data generally require domain-specific expert knowledge to interpret raw genetic information and to track ongoing advances in genetic research. As a result, ordinary users and even non-specialist healthcare providers face difficulties in understanding the clinical significance of genetic variants and in obtaining timely, personalized information on risks, treatment options, and lifestyle recommendations. Furthermore, as the volume and sensitivity of genetic data increase, there is a heightened need for strict privacy protection and access control, while still enabling effective analysis and information delivery. Existing solutions either depend heavily on human experts, cannot keep pace with rapidly evolving genetic research, or do not provide sufficient mechanisms to ensure robust encryption and access control for genetic data. Therefore, there is a demand for a system that can automatically analyze user-provided genetic information using a generative artificial intelligence model, generate user-friendly and up-to-date information without requiring expert knowledge, and manage sensitive genetic data in a secure and privacy-preserving manner.

### SUMMARY

To solve the above problems, the invention provides a system comprising a processor, wherein the processor is configured to receive genetic information from a user, generate a prompt for a generative artificial intelligence model in order to analyze the received genetic information, generate information based on a result obtained from the generative artificial intelligence model using the generated prompt, and provide the generated information to the user. In one aspect, the processor is configured to generate, without requiring expert knowledge, a prompt for the generative artificial intelligence model to generate information for tracking progress in genetic research, thereby enabling automatic acquisition and presentation of up-to-date research findings and treatment-related information relevant to the user's genetic profile. In another aspect, the processor is configured to encrypt data and perform access control in order to strictly manage genetic data while maintaining privacy, thereby ensuring that sensitive genetic information is protected against unauthorized access or misuse. By combining automated prompt generation for a generative artificial intelligence model with secure data management functions, the system enables non-expert users to obtain personalized, current genetic information while preserving the confidentiality and integrity of their genetic data.

The term “system” refers to an arrangement of one or more hardware and/or software components that cooperate to perform one or more functions described herein.

The term “processor” refers to any hardware element, or combination of hardware elements, capable of executing instructions, including but not limited to a central processing unit (CPU), a microcontroller, a digital signal processor (DSP), a graphics processing unit (GPU), a dedicated accelerator, or a combination thereof.

The term “user” refers to any human individual or authorized entity that provides genetic information to the system and receives information generated by the system.

The term “genetic information” refers to data representing one or more characteristics of an individual's genome, including but not limited to gene names, genetic variants, mutation annotations, sequence data, or results of genetic tests.

The term “generative artificial intelligence model” refers to a machine learning model configured to generate output data, such as text or structured information, in response to an input, the output being derived from patterns learned from training data rather than being limited to predetermined fixed responses.

The term “prompt” refers to data provided as input to the generative artificial intelligence model, the data including at least one instruction, question, or contextual description that causes the generative artificial intelligence model to generate a corresponding output.

The term “analyze the received genetic information” refers to processing the genetic information to derive clinically or scientifically relevant interpretations, correlations, or inferences, including but not limited to identifying variants, associated risks, potential treatments, or research-related findings.

The term “generate information” refers to producing, based on a result obtained from the generative artificial intelligence model, output data that includes at least one of explanatory text, summaries, recommendations, or other interpretive content related to the genetic information.

The term “provide the generated information to the user” refers to outputting the generated information in a form accessible to the user, including but not limited to displaying the information on a screen, transmitting the information to a client device, or storing the information for later retrieval by the user.

The term “without requiring expert knowledge” refers to enabling the operation or use of the system by a user who does not possess specialized training or professional expertise in genetics, bioinformatics, or artificial intelligence.

The term “information for tracking progress in genetic research” refers to information that reflects developments in the field of genetics, including but not limited to newly reported genetic variants, associations between genes and diseases, new therapeutic approaches, and clinical trial results.

The term “encrypt data” refers to transforming data using a cryptographic algorithm and one or more keys such that the data is unreadable without corresponding decryption, thereby protecting the data against unauthorized access.

The term “access control” refers to mechanisms that regulate access to data or system functions based on one or more criteria, including but not limited to authentication, authorization, user roles, or permissions, in order to prevent unauthorized use, disclosure, or modification of data.

The term “strictly manage genetic data” refers to handling genetic data according to predefined security and privacy policies, including at least encryption, access control, logging, and, where applicable, restrictions on storage, transmission, and processing.

The term “maintaining privacy” refers to protecting information relating to an identified or identifiable individual such that the information is not disclosed or used beyond authorized purposes and is safeguarded against unauthorized access or exposure.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

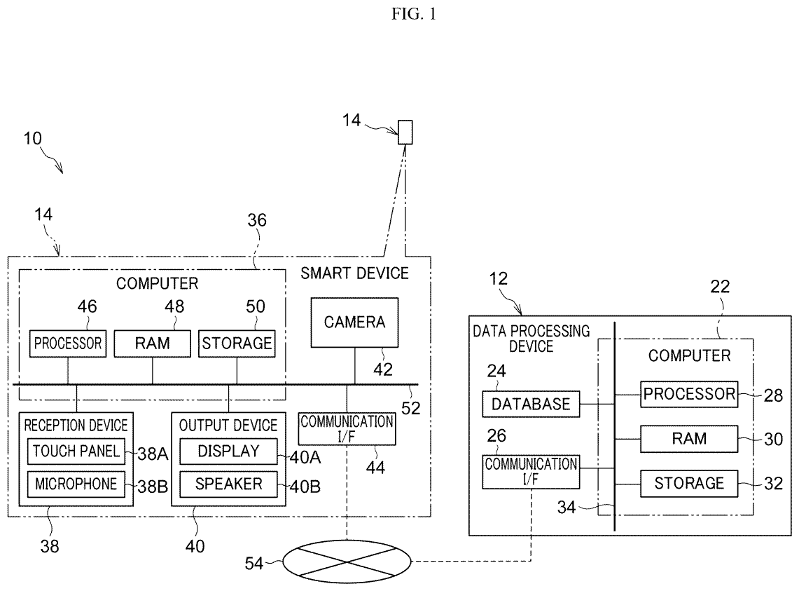

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

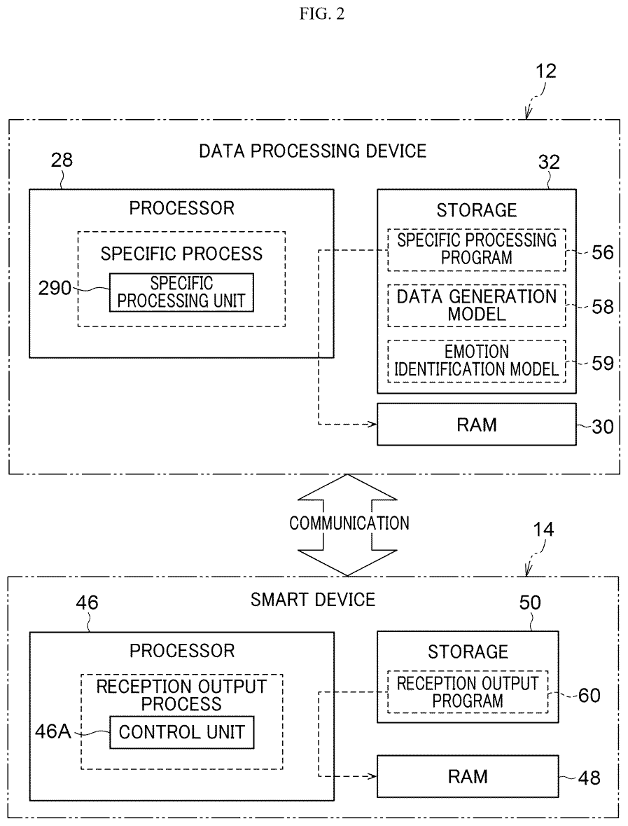

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### EXAMPLE 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented systems that provide medical information based on genetic or other biological-related information typically rely on static rule sets or manually crafted queries to external knowledge sources. Such systems suffer from several technical drawbacks in terms of data handling and information generation. First, the systems often accept only loosely structured biological-related information, which leads to ambiguous internal representations, limited possibilities for automated validation, and frequent parsing errors in downstream processing. Second, when a generative AI model is used as a back-end component, the prompt design is frequently ad hoc and non-systematic, resulting in non-deterministic outputs, inconsistent granularity of explanation, and difficulty in reproducing results for auditing and re-use. Third, the systems generally lack a mechanism for persistently linking the original biological-related information, the specific prompt sentences provided to the generative AI model, and the generated outputs, which makes it technically difficult to trace the origin of each piece of individualized medical-related information, to debug failures, or to refine prompt-generation logic over time.

Additionally, known systems tend to treat user follow-up questions as separate, isolated sessions, without maintaining explicit context at the level of machine-readable structures. As a result, the generative AI model may not correctly incorporate the full history of biological-related information and prior advice, which leads to fragmented guidance and increased computational load due to repeated re-explanation of background conditions. From a computer-technical standpoint, the absence of a structured, template-based prompt generation layer also prevents effective optimization of model inputs and increases network and computation overhead, because prompts may contain redundant or irrelevant text.

Further, existing approaches frequently store biological-related information and generated outputs either in raw, non-normalized form or in coarse-grained logs that mix personally identifiable data with analysis content. This storage pattern complicates the implementation of robust access control and anonymization, and makes it difficult to derive analysis datasets that are properly decoupled from user-identifying data. Consequently, it is technically challenging to safely reuse historical data for performance evaluation or improvement of the generative AI model, or for testing the stability of prompt designs, without exposing sensitive information or requiring extensive manual sanitization.

Accordingly, there is a need for an improved computer-implemented system that: (i) systematically normalizes and validates incoming biological-related information and enriches it with attribute information; (ii) automatically generates structured, template-based prompt sentences for a generative AI model in a way that preserves context and supports iterative, follow-up queries; (iii) tightly couples generated individualized information with the underlying prompts and biological-related information; and (iv) provides built-in mechanisms for encryption, usage-authorization control, and automated anonymization or pseudonymization, thereby enabling technically efficient, secure, and reproducible use of generative AI models for individualized medical-related information generation.

The specific processing by the specific processing unit 290 of the data processing device 12 in Example 1 is realized by the following means.

The present invention provides a server comprising a processor and a storage device, the processor being configured to receive, from a terminal, structured data including biological-related information acquired from a user, to normalize and validate the biological-related information and to obtain and append attribute information from the storage device, to automatically generate a template-based prompt sentence for input to a generative information processing model based on the normalized biological-related information and the attribute information, to input the prompt sentence to the generative information processing model and obtain generated information including individualized medical-related information, to generate individualized information including risk assessment information, medical procedure candidate information, and lifestyle guidance candidate information based on the generated information and the attribute information, to transmit the individualized information as visualization-structured data to the terminal for dashboard-type and interactive presentation, and to store and manage, in the storage device, the biological-related information, the prompt sentence, the generated information, and the individualized information together with encryption processing and usage-authorization control processing, and the processor further being configured to dynamically generate supplemental prompt sentences including follow-up questions from the user and to generate anonymized or pseudonymized analysis data from the stored information for performance evaluation or improvement of the generative information processing model. This enables a computer-implemented improvement in how biological-related information is structurally represented, how prompt sentences for a generative AI model are automatically and reproducibly generated, how individualized medical-related information is derived and presented with reduced computational redundancy, and how sensitive data is securely stored and reused for model evaluation while maintaining strict control over access and identifiability.

The term “processor” refers to a hardware information processing unit, such as a central processing unit or other computing circuitry, configured to execute instructions that implement the functions described in the present disclosure.

The term “terminal” refers to an electronic client apparatus, such as a communication device or display device, that acquires biological-related information from a user and transmits the biological-related information to a server, and that presents information received from the server to the user.

The term “user” refers to a human individual who provides biological-related information to the terminal and who receives individualized medical-related information via the terminal.

The term “biological-related information” refers to data representing characteristics of a living body, including but not limited to genomic information, genetic variation information, clinical biomarker information, physiological measurement information, and health status information, in any machine-readable format.

The term “structured data” refers to biological-related information and associated items represented in a predefined data structure, such as a record or an object with defined fields, enabling deterministic parsing, validation, and storage by a computer system.

The term “attribute information” refers to additional information associated with the biological-related information, including but not limited to demographic information, clinical background information, family history information, and user profile information, that is used to contextualize and individualize medical-related information.

The term “normalize” refers to processing that converts biological-related information or attribute information into a standardized representation, including but not limited to standardizing notation, resolving synonyms, and enforcing canonical formats, to facilitate consistent computation and storage.

The term “validate” refers to processing that checks whether biological-related information or attribute information satisfies predefined constraints, such as format constraints, value ranges, or consistency rules, and that detects or rejects data not satisfying the constraints.

The term “storage device” refers to a physical or logical data storage resource, such as a non-transitory computer-readable storage medium, database, or storage subsystem, used to store biological-related information, attribute information, prompt sentences, generated information, and individualized information.

The term “template information” refers to machine-readable definition data describing a structure or pattern of a prompt sentence, including fixed text and placeholder elements, that is used by the processor to construct a prompt sentence according to biological-related information and attribute information.

The term “prompt sentence” refers to a natural-language or semi-structured text sequence provided as input to a generative information processing model, the content of which instructs the model regarding a task to be executed and context to be considered for generating output.

The term “generative information processing model” refers to a machine-learned computational model, such as a neural network including a generative AI model, that generates output information in response to input information including a prompt sentence, by performing probabilistic inference and pattern-based reasoning over learned parameters.

The term “generated information” refers to information output from the generative information processing model based on a prompt sentence, including but not limited to explanations, assessments, recommendations, or summaries related to biological-related information and attribute information.

The term “individualized information” refers to information that is generated by combining the generated information with attribute information, the individualized information being adapted to a specific user or biological-related information instance and including at least a portion of risk assessment information, medical procedure candidate information, and lifestyle guidance candidate information.

The term “risk assessment information” refers to information that characterizes a likelihood or severity of occurrence of a medical condition or health-related event for a specific user or biological-related information instance, and that may be represented as a qualitative category, a quantitative score, or a probability.

The term “medical procedure candidate information” refers to information that identifies or describes one or more candidate medical actions, such as diagnostic tests, therapeutic interventions, or surveillance procedures, that may be applicable to a user based on the biological-related information and attribute information.

The term “lifestyle guidance candidate information” refers to information that identifies or describes one or more candidate lifestyle-related behaviors, such as diet, exercise, or habit modifications, that may be recommended to a user based on the biological-related information and attribute information.

The term “visualization-structured data” refers to a representation of individualized information that is organized into fields, values, and layout-related parameters suitable for graphical presentation on a display device, such as data for charts, tables, sections, or dashboards.

The term “dashboard-type display” refers to a display format in which multiple pieces of individualized information, such as risk indicators, recommendations, and summaries, are simultaneously presented in an integrated layout including graphical elements, textual elements, and interactive controls.

The term “interactive operation screen” refers to a user interface screen that allows a user to perform operations such as selecting items, expanding details, submitting follow-up questions, or navigating among sections, whereby the user can actively interact with individualized information.

The term “encryption processing” refers to computational processing that transforms biological-related information or other data into an encrypted representation using a cryptographic algorithm, such that the original information is not directly readable without corresponding decryption processing.

The term “usage-authorization control processing” refers to processing that controls access to stored data and functions based on authentication information, authorization information, or role information, such that only permitted entities or processes can read, write, or modify the data.

The term “follow-up question” refers to additional input information provided by a user after initial individualized information has been presented, the additional input information requesting clarification, further detail, or additional advice related to the same underlying biological-related information.

The term “supplemental prompt sentence” refers to a prompt sentence that includes at least a portion of previous context related to biological-related information and individualized information, and additionally includes a follow-up question or other additional input information, and that is provided to the generative information processing model to obtain additional explanation information.

The term “additional explanation information” refers to information generated by the generative information processing model in response to a supplemental prompt sentence, and that provides clarification, extension, or refinement of previously generated individualized information.

The term “analysis data” refers to data derived from biological-related information, generated information, or individualized information, from which personal identification information has been removed or replaced, and which is used for evaluation, testing, or improvement of the generative information processing model or a related information processing model.

The term “anonymize or pseudonymize” refers to processing that removes, transforms, or replaces personal identification information in data so that the data cannot be directly associated with a specific individual, or can be associated only through controlled linkage mechanisms.

The term “related information processing model” refers to a machine-learned or rule-based computational model other than the primary generative information processing model, which uses analysis data to perform tasks such as risk scoring, validation, summarization, or prompt optimization.

In the following embodiments, a server, a terminal, and a user cooperate to implement the claimed system. The same reference architecture and terminology as in the claims are used for clarity. The embodiments described below are examples and do not limit the scope of the invention.

### A. Overall Hardware and Software Configuration

Server includes a processor, a storage device, a communication interface, and a memory storing executable instructions. Server is realized, for example, by a general-purpose computer or a rack-mount computing node running an operating system such as a general-purpose server operating system. Server executes middleware such as a web server and an application framework. In one embodiment, server executes an application implemented in a high-level programming language using a web application framework, and uses a relational database management system as the storage device.

Terminal includes a processor, a display, an input device, a camera or dedicated code reader, a communication module, and a local memory. Terminal is realized, for example, by a portable communication device such as a smartphone or tablet computer, or by a specialized clinical input device. Terminal executes an application that interacts with server through a network. The network may include at least one of a wireless communication network and a wired communication network and supports secure transport protocols. User is a human individual, such as a patient or a healthcare professional, who operates terminal, provides biological-related information, and views individualized medical-related information on terminal.

### B. Data Structures for Biological-related Information and Attribute Information

Server uses explicit data structures to represent biological-related information and attribute information. Biological-related information includes, for example, gene symbols, genetic variant notations, variant classifications, and optional laboratory measurement values. Server represents this information internally as records with predefined fields, such as a gene identifier field, a variant descriptor field, a classification field, and a measurement field. Server uses attribute information to represent contextual data about user. Attribute information includes at least one of age, biological sex, relevant family history flags, previous diagnoses, and treatment history flags. Server stores attribute information as records in the storage device, for example, in a user profile table. Each profile record is linked to a user identifier, and includes normalized codes for demographic and clinical items. By enforcing explicit record formats for biological-related information and attribute information, server enables deterministic parsing and avoids ambiguous free-text representations. This structured representation improves both validation accuracy and computational efficiency when constructing prompt sentences and when correlating generated information with underlying data.

### C. Template-based Prompt Sentence Generation

Server maintains template information in the storage device. Template information includes multiple prompt templates, each identified by a template identifier and associated with conditions such as target gene categories, variant classification categories, and user attribute ranges. Each template contains fixed text segments and placeholders for fields such as age, sex, gene name, variant descriptor, and clinical context.

For example, server can store template information including the following text strings: “A [AGE]-year-old [SEX] with a [CLASSIFICATION] variant in the [GENE] gene asks about cancer risk, recommended screening, and lifestyle advice. Provide a clear explanation suitable for a non-specialist patient.”

“Genetic variant: [GENE] [VARIANT], classified as [CLASSIFICATION]. Explain the latest treatment options, surveillance strategies, and lifestyle recommendations, focusing on cancer risk associated with this variant.”

Server selects a template based on rule evaluation over the structured biological-related information and attribute information. For instance, when server receives biological-related information containing a high-risk variant in a tumor-suppressor gene and attribute information indicating adult age and a particular biological sex, server selects a template configured for high-risk cancer predisposition scenarios. This rule-based selection is executed in processor, using logical conditions and possibly decision tables stored in the storage device.

Server generates a concrete prompt sentence by replacing placeholders in the selected template with actual values from the normalized biological-related information and attribute information. For example, if server detects that user has a pathogenic variant in a particular gene and is a 42-year-old female, server generates a prompt sentence such as:

“A 42-year-old female with a pathogenic variant in the BRCA1 gene asks about cancer risk, recommended screening, and lifestyle advice. Provide a clear explanation suitable for a non-specialist patient.”

Server optionally prepends additional context derived from the structured records, such as: “Genetic variant: BRCA1 c.68_69delAG, classified as pathogenic. A 42-year-old female with a pathogenic variant in the BRCA1 gene asks about cancer risk, recommended screening, and lifestyle advice. Provide a clear explanation suitable for a non-specialist patient, including breast and ovarian cancer risk and preventive options.”

This template-based construction constitutes a specific algorithm for prompt sentence generation. Because server maps discrete data fields into a fixed text structure, server can systematically control the length, content, and ordering of information in the prompt sentence, which directly affects the stability and reproducibility of outputs from the generative AI model. This differs from ad hoc or manual prompt composition and leads to reduced variance in generated information and reduced need for manual editing.

### D. Generative AI Model Architecture and Server-side Integration

Server includes or accesses a generative information processing model implemented as a neural network. In one embodiment, the generative AI model is a transformer-based sequence model having multiple attention layers, feed-forward layers, and layer normalization components. The model is parameterized by a large number of weight parameters, and is trained on a corpus including medical text, clinical guidelines, and general language data. The model uses token embeddings, positional encodings, and multi-head self-attention mechanisms to compute context-aware representations of tokens in a prompt sentence. Server executes inference on the generative AI model either locally or remotely. In a local deployment, server uses a numerical computation framework to perform tensor operations required by the transformer network. The framework performs matrix multiplications, softmax operations, and non-linear activations across multiple cores of the processor, thereby enabling high-throughput generation. In a remote deployment, server formats requests to an external model-serving system, which executes the transformer inference and returns token sequences.

In both configurations, server controls model generation parameters such as maximum output length (token count), sampling temperature, top-k or top-p sampling thresholds, and penalty parameters for repetition. Server selects these parameters based on the type of biological-related information and intended use; for example, server can lower the temperature and limit maximum length for concise risk summaries, thereby improving determinism and processing time. Server thereby treats the generative AI model as a configurable computational component and not merely as a remote black box.

To generate output, server converts the prompt sentence into a sequence of tokens using a tokenizer consistent with the generative AI model, and supplies this sequence to the model. The model computes layer-by-layer activations and outputs probability distributions over next tokens. Server decodes these distributions into text using beam search or constrained sampling, yielding generated information. During this decoding, server can apply constraints such as forcing the inclusion of specific medical concepts or restricting certain types of undesired terms. These decoding-level constraints are implemented algorithmically in server and lead to improved alignment of generated information with clinical expectations and readability requirements.

### E. Post-processing and Individualized Information Generation

Server applies explicit text-processing algorithms to the generated information. Server segments the generated information into logical sections by scanning for headings, key phrases, and patterns. Server can use text processing libraries to identify sentences referring to risk levels, screening intervals, invasive procedures, and lifestyle modifications. For example, server can detect phrases such as “increased risk,” “annual MRI,” “screening starting at age 30,” and “prophylactic surgery.”

Based on this analysis, server constructs individualized information objects with explicit fields for risk assessment information, medical procedure candidate information, and lifestyle guidance candidate information. In one embodiment, server uses a rule-based classifier that maps detected phrases to structured labels. For example, a phrase indicating “annual breast MRI” is mapped to a medical procedure candidate of type “imaging surveillance” with interval “12 months.” This mapping enables machine-readable representation of recommendations, which in turn supports graphical visualization and further computation. Server combines the structured output with attribute information. For example, server can adjust recommended screening start age based on the actual age of user, or can emphasize certain lifestyle recommendations when attribute information indicates specific risk factors such as family history. This combination is computed algorithmically using conditional rules or auxiliary models. As a result, individualized information is not merely a direct text output from the generative AI model, but a composite of structured inference and context-sensitive adjustment executed by server.

Because server processes generated information into structured individualized information, server can avoid repeatedly generating equivalent text for similar users. Server can cache structured recommendations for particular combinations of gene, variant classification, and attribute ranges and reuse them with minimal adaptation. This reduces the number of generative model invocations and decreases computation cost and latency, thereby improving system performance.

### F. Data Management, Encryption, and Anonymization

Server stores biological-related information, prompt sentences, generated information, and individualized information in the storage device. Server implements encryption processing at the application level or at the storage system level. For example, server applies symmetric-key encryption to critical fields before writing them to the storage device. Decryption keys are managed by a key management component separate from the application logic. By encrypting data at rest in a granular manner, server reduces the risk of leakage and allows fine-grained control over which components can access decrypted content.

Server implements usage-authorization control processing based on access tokens or session identifiers. Server associates each record with a user identifier and access policy metadata. When server receives a request for stored data, server verifies that the authenticated entity has a permission role compatible with the requested operations. Access policies may differentiate between full record access for authorized healthcare providers and limited access for model evaluation modules, which may only use anonymized information.

For anonymization or pseudonymization, server derives analysis data from stored information by removing or replacing direct identifiers, such as names, contact information, and internal user identifiers. Server replaces such identifiers with pseudonymous codes or omits them entirely. Server also coarsens certain attribute information fields, such as converting exact ages into age ranges. Server stores analysis data in a separate storage structure or marks it with metadata indicating that it contains no direct identifiers.

Server uses analysis data for performance evaluation or improvement of the generative information processing model and related models. For example, server can compute statistics on generated recommendation patterns, check consistency across similar biological-related information, and adjust template selection rules or decoding parameters based on these observations. Because server performs this evaluation only on analysis data, server can safely execute large-scale computations without exposing personally identifiable information.

### G. Terminal-side Acquisition and Visualization

Terminal acquires biological-related information by controlling hardware components such as a camera or a code reader. Terminal decodes barcodes, two-dimensional codes, or other machine-readable symbols printed on laboratory reports. Terminal converts these codes into digital text and parses them into structured fields. Terminal may display an edit screen where user can correct or supplement fields. This hardware-level cooperation with optical sensors demonstrates that the system is tied to concrete machinery rather than being a purely abstract process.

Terminal receives visualization-structured data from server and renders a dashboard-type display. Terminal draws graphical elements such as risk gauges, colored bars, and time axes for screening schedules. Terminal uses interactive widgets that enable user to expand or collapse sections, access definitions of technical terms, and submit follow-up questions directly from the displayed screen. Because server sends data in a structure optimized for visualization, terminal can render complex dashboards with minimal client-side computation, contributing to reduced processor burden on terminal and predictable user-interface performance.

### H. Follow-up Questions and Context-preserving Supplemental Prompts

User may ask follow-up questions after reviewing individualized information. Terminal captures free-text queries from user and transmits them to server along with a reference to the existing record. Server retrieves underlying biological-related information, attribute information, original prompt sentences, and prior generated information. Server then builds a supplemental prompt sentence that concatenates a concise machine-generated context summary and the user's question.

For example, server can generate a supplemental prompt sentence such as:

“Context: The patient is a 42-year-old female with a pathogenic BRCA1 c.68_69delAG variant. Previous advice included consideration of prophylactic mastectomy and annual MRI screening. Question: The patient asks, ‘What does prophylactic mastectomy mean, and what are its pros and cons?’ Provide a concise, patient-friendly explanation.”

Server supplies this supplemental prompt sentence to the generative AI model. Because server explicitly includes only a condensed context rather than entire prior outputs, server reduces token length and inference time while still preserving necessary information. This reduces communication load and processing overhead. Additionally, server stores the mapping between the supplemental prompt sentence and the new generated information, thereby enabling auditability and reproducibility of follow-up guidance.

### I. Technical Effects and Improvement of Computer Technology

The described architecture provides several technical improvements over conventional systems that simply passively relay input to a generative AI model. First, server enforces structured representation and normalization of biological-related information and attribute information. This reduces ambiguity and parsing errors, enabling more accurate and efficient computation when selecting templates and generating prompt sentences. Because template selection is executed by explicit algorithms and data structures, system behavior is more predictable, and the processor can skip redundant generic text, which reduces the token count in prompt sentences and shortens inference time.

Second, server's template-based prompt generation constitutes a specific algorithm for minimizing unnecessary content in prompts and for arranging content in a format that aligns with the internal behavior of transformer-based generative models. By matching prompt composition to model characteristics, server reduces the variance of outputs and improves the repeatability of recommendations for similar input conditions. This improves computational efficiency because fewer repeated model calls or manual corrections are required.

Third, server converts unstructured generated text into structured individualized information. This extra level of computation enables caching of structured recommendations, targeted modifications based on user attributes, and systematic detection of conflicts or anomalies across outputs. These technical effects manifest as lower processor utilization on the generative model engine and improved throughput, especially when many users share similar genetic contexts.

Fourth, server integrates encryption, usage-authorization control, and automated anonymization into the same data model that is used for prompt generation and analysis. Because server stores explicit links between biological-related information, prompt sentences, and generated outputs, server can selectively anonymize only fields required for model evaluation while preserving internal relationships among records. This allows model-evaluation processes to operate with full contextual structure but without sensitive identifiers, improving both security and the quality of evaluation.

Fifth, by aligning hardware-level acquisition on terminal (via camera or code reader) with structured processing and visualization, the system reduces manual data entry errors and streamlines the flow from physical laboratory output to individualized information. Terminal's use of structured visualization-structured data reduces per-device customization and allows lightweight clients to render complex dashboards efficiently, improving performance on limited hardware.

Finally, the generative AI model is not used as a generic black box, but is integrated with explicit algorithms controlling prompt composition, token limits, sampling parameters, and decoding constraints. Server uses the internal structure of the transformer architecture—such as sequence length sensitivity and attention-based context representation—to optimize prompt sentences and decode strategies. This integration yields quantifiable improvements in processing speed, output consistency, and error reduction, demonstrating an improvement to computer technology itself rather than merely automating a human mental process.

### J. Variations and Alternative Embodiments

Server may employ different generative AI architectures, such as encoder-decoder transformers, recurrent neural networks with attention, or hybrid models that combine retrieval-based components with generative components. Server can adjust training or fine-tuning methods, such as supervised learning on curated medical texts, reinforcement learning with human feedback to align outputs with clinical guidelines, or data augmentation strategies that synthesize variant scenarios for robust generalization.

Server may implement rule-based post-processing using different linguistic analysis techniques, such as dependency parsing or semantic role labeling, to extract recommendation structures from generated text. Server may also incorporate auxiliary models, such as classification models for risk-tier assignment or regression models for numeric risk estimation, which use embeddings or features derived from both structured data and generated text.

Terminal may vary in form factor, including wearable devices or dedicated kiosks. Terminal may execute pre-validation routines locally to reduce the amount of invalid data sent to server, thereby reducing network and server load. Terminal may adapt visualization-structured data to accessibility requirements, such as large fonts or audio output, using metadata included by server.

User may be a clinician, in which case server can select templates containing more technical terminology and more detailed references to guidelines, while still maintaining a structured prompt and structured individualized information. In that case, server can adjust prompt sentences, for example:

“For a clinician: Summarize evidence-based management guidelines, including recommended screening modalities, intervals, and indications for risk-reducing surgery, for a patient with a pathogenic BRCA1 c.68_69delAG variant.”

These and other variations remain within the scope of the invention, provided that server, terminal, and user cooperate such that server receives structured biological-related information, generates template-based prompt sentences for a generative AI model, computes individualized information by structured post-processing, and manages data with encryption, authorization, and anonymization features as described.

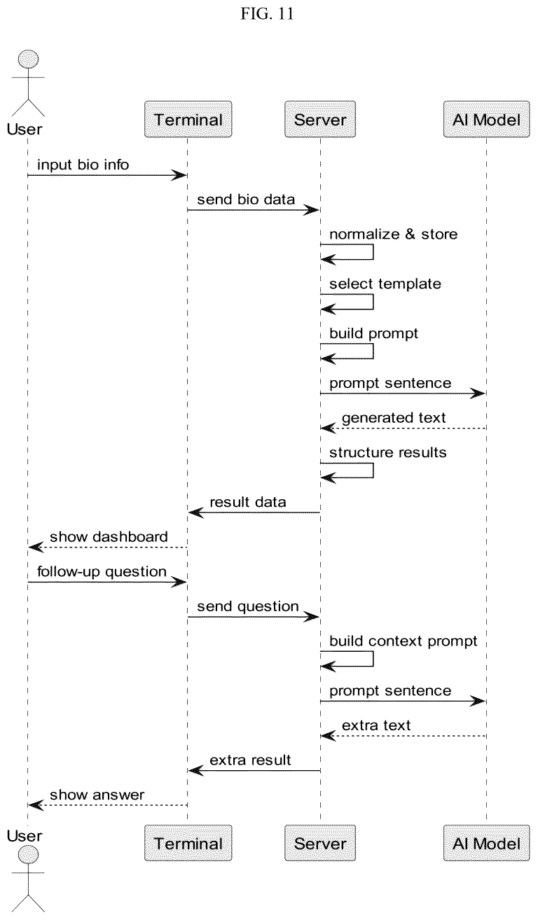

The following describes the processing flow using FIG. 11.

### Step 1:

User operates terminal to acquire biological-related information.

Terminal receives, as input, raw optical data captured by a camera or a code reader from a barcode or a two-dimensional code printed on a laboratory report.

Terminal decodes the optical pattern into text data, parses the text data into internal fields such as gene symbol, variant notation, and variant classification, and constructs a structured data object in memory.

Terminal outputs the structured biological-related information to a display preview screen so that user can visually confirm and, if necessary, correct the decoded content.

### Step 2:

User reviews and edits biological-related information on terminal.

Terminal receives, as input, user operations such as keystrokes and touch events indicating corrections to gene names, variant descriptors, and additional attribute information such as age, sex, and family history flags.

Terminal validates the edited values by checking format rules, such as verifying that age is within a plausible range and that gene symbols match allowed patterns, and updates the structured data object accordingly.

Terminal outputs a finalized, locally validated biological-related information record that will be sent to server.

### Step 3:

Terminal transmits structured biological-related information to server.

Terminal receives, as input, the finalized structured data object and an authentication token previously issued during login.

Terminal serializes the structured data object into a communication format, attaches the authentication token in a header, encrypts the communication channel using a secure transport protocol, and sends a request message to server.

Terminal outputs the request message onto the network, where server can receive it for further processing.

### Step 4:

Server receives and authenticates the incoming request.

Server receives, as input, a request message containing serialized biological-related information, attribute information, and an authentication token.

Server verifies the token by decoding and checking its signature, expiration, and permission claims, and rejects the request if the checks fail or accepts it if the checks succeed. Server outputs either an authentication failure response or a validated request context containing the parsed biological-related information and associated user identifier.

### Step 5:

Server normalizes and validates biological-related information.

Server receives, as input, the structured biological-related information and attribute information from the validated request context.

Server applies normalization rules, such as converting gene symbols to a canonical case, converting variant notations to standardized formats, and mapping free-text classifications to controlled vocabulary codes.

Server performs validation by matching gene symbols to a reference gene table and checking variant patterns against regular expressions, and discards or flags inconsistent entries.

Server outputs a normalized and validated biological-related information record with associated attribute information, ready for storage and prompt construction.

### Step 6:

Server stores normalized information and retrieves additional attribute information.

Server receives, as input, the normalized and validated biological-related information record and a user identifier.

Server writes the record into a database table, assigning a unique request identifier, and retrieves any missing or additional attribute information from a user profile table via keyed lookup.

Server merges the retrieved attribute information into the record, resolving conflicts by applying precedence rules, and updates the database entry.

Server outputs an enriched data record that includes both normalized biological-related information and comprehensive attribute information.

### Step 7:

Server selects a prompt template based on the enriched data.

Server receives, as input, the enriched data record and a set of template metadata stored in the database or configuration.

Server evaluates selection rules using the gene category, variant classification, age range, and other attributes, and computes which template identifier best matches the conditions, for example using conditional logic or a decision table.

Server outputs a selected template that contains fixed text segments and placeholder markers for fields such as age, sex, gene, and variant.

### Step 8:

Server generates a concrete prompt sentence for the generative AI model.

Server receives, as input, the selected template and the enriched data record.

Server replaces placeholders in the template with concrete values, such as substituting numerical age, textual sex descriptor, standardized gene name, and variant notation, and concatenates optional sections describing additional context.

Server may, for example, generate a prompt sentence such as: “Genetic variant: BRCA1 c.68_69delAG, classified as pathogenic. A 42-year-old female with a pathogenic variant in the BRCA1 gene asks about cancer risk, recommended screening, and lifestyle advice.

Provide a clear explanation suitable for a non-specialist patient, including breast and ovarian cancer risk and preventive options.”

Server outputs the fully constructed prompt sentence as a text string ready for input to the generative AI model.

### Step 9:

Server invokes the generative AI model with the prompt sentence.

Server receives, as input, the prompt sentence and configuration parameters such as maximum token length and sampling temperature.

Server tokenizes the prompt sentence into numerical token identifiers, feeds them into the generative AI model, and executes forward passes through the model's layers, including attention computations and feed-forward transformations, to compute probability distributions for subsequent tokens.

Server decodes the token distributions into natural language text using a decoding algorithm such as beam search or constrained sampling to avoid unrealistic or forbidden sequences.

Server outputs generated information in the form of one or more text passages that describe risks, screening options, treatment possibilities, and lifestyle considerations.

### Step 10:

Server post-processes generated information into structured segments.

Server receives, as input, the generated information text and the enriched data record.

Server analyzes the text using linguistic processing, such as sentence segmentation and keyword search, to detect parts that describe risk assessment, parts that mention medical procedures, and parts that include lifestyle recommendations.

Server assigns tags to these parts, extracts them into separate fields, and encodes them into a structured representation that distinguishes between risk assessment information, medical procedure candidate information, and lifestyle guidance candidate information.

Server outputs a preliminary individualized information structure that organizes the content into labeled sections.

### Step 11:

Server refines individualized information based on attribute information.

Server receives, as input, the preliminary individualized information structure and the attribute information from the enriched data record.

Server applies rules such as adjusting recommended screening ages to match the user's current age, emphasizing or de-emphasizing certain procedures based on family history flags, and filtering out recommendations that are incompatible with the user's demographic profile.

Server may also adjust language complexity by replacing or appending simpler explanations when attribute information indicates that user is a non-specialist.

Server outputs a refined individualized information structure that is specifically tailored to the user's biological-related information and context.

### Step 12:

Server converts individualized information into visualization-structured data.

Server receives, as input, the refined individualized information structure.

Server maps numeric or categorical risk levels to visualization parameters such as color codes, gauge positions, or bar lengths, and organizes recommendations into arrays with labels and ordering metadata suitable for list or chart rendering.

Server packages text segments, numeric values, and visualization metadata into a composite data object.

Server outputs visualization-structured data that can be rendered as a dashboard-type display and interactive screen by terminal.

### Step 13:

Server transmits visualization-structured data to terminal and stores related records.

Server receives, as input, the visualization-structured data and the request identifier.

Server sends a response message containing the visualization-structured data to terminal over a secure communication channel, and in parallel, stores the prompt sentence, generated information, and refined individualized information in the database, associating them with the same request identifier and applying encryption to sensitive fields.

Server updates access control metadata so that only authorized entities can retrieve these records in the future.

Server outputs a completed response to the network and a set of securely stored records in the storage device.

### Step 14:

Terminal renders the dashboard-type display and interactive screen.

Terminal receives, as input, the visualization-structured data from server.

Terminal interprets visualization parameters to draw graphical elements such as risk gauges, charts, and section headers, and arranges text segments under appropriate headings for risk, procedures, and lifestyle advice.

Terminal activates interactive controls so that user can tap items to expand details or scroll through sections.

Terminal outputs a displayed screen where user can visually inspect individualized information and interact with it.

### Step 15:

User submits a follow-up question through terminal.

Terminal receives, as input, a follow-up question typed or selected by user in an input field associated with the current record.

Terminal combines the text of the follow-up question with a reference to the current request identifier and sends these data to server over the secure communication channel.

Terminal outputs a follow-up request message that server can correlate with previously stored biological-related information and individualized information.

### Step 16:

Server constructs a supplemental prompt sentence for the follow-up question.

Server receives, as input, the follow-up request message including the follow-up question and request identifier.

Server retrieves the associated biological-related information, attribute information, original prompt sentence, and key elements of prior individualized information from the database, and synthesizes a concise context summary.

Server concatenates the context summary with the follow-up question into a supplemental prompt sentence such as: “Context: The patient is a 42-year-old female with a pathogenic BRCA1 c.68_69delAG variant. Previous advice included consideration of prophylactic mastectomy and annual MRI screening. Question: The patient asks, ‘What does prophylactic mastectomy mean, and what are its pros and cons?’ Provide a concise, patient-friendly explanation.”

Server outputs the supplemental prompt sentence as a new input string for the generative AI model.

### Step 17:

Server generates additional explanation information using the generative AI model.

Server receives, as input, the supplemental prompt sentence and corresponding model configuration parameters.

Server tokenizes the supplemental prompt sentence, executes inference in the generative AI model to compute token probabilities conditioned on the context and question, and decodes the output into additional explanation text.

Server optionally filters or segments the explanation into logically coherent parts and tags them as follow-up content linked to the original record.

Server outputs additional explanation information, which can be merged into the existing individualized information and sent back to terminal for display.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional systems that provide health guidance based on genetic or other biological information typically follow a static, rule-based workflow. Such systems generally map a limited set of genetic markers to prewritten recommendations without dynamically adapting to newly available medical knowledge, cost information, or user-specific constraints. As a result, they often fail to generate up-to-date, personalized, and cost-effective health-related expenditure plans.

In addition, existing systems that employ machine learning models for risk prediction usually confine the models to numerical analysis and present raw scores or fixed-format text. These systems do not integrate a generative AI model through a structured prompt design that jointly encodes model outputs, cost-effectiveness information, and user feedback in a machine-interpretable manner. Consequently, the computational pipeline remains fragmented: predictive models operate in isolation from natural-language generation components, and there is no unified mechanism for iteratively refining recommendations in response to user interaction while preserving technical consistency and traceability. Further, many health-related recommendation platforms treat cost information and medical outcome information as separate layers handled outside the core computation. This separation hinders automated cost-effectiveness optimization at the system level and forces manual curation or static pricing assumptions. From a computer-technology perspective, the data structures, storage mechanisms, and processing sequences are not optimized to handle the combined lifecycle of (i) high-dimensional biological feature data, (ii) model-generated health indicators, (iii) structured cost and effect data, and (iv) prompt sentences for a generative AI model, all under strict privacy and access control policies.

Moreover, conventional data protection measures are often applied in a coarse-grained manner, such as encrypting entire databases or storage volumes, without tightly coupling access control, encryption, and model-level traceability. This makes it difficult to implement fine-grained management of sensitive inputs and outputs, including the prompts sent to the generative AI model and the generated recommendations that may embed inferred health conditions. Without explicit linkage between storage records, model versions, and prompts, system operators cannot reliably audit or reproduce specific recommendation sessions, which is a limitation in safety-critical and regulated environments.

Accordingly, there is a need for an improved computer-implemented system that: (i) transforms biological information into feature data suitable for statistical learning models; (ii) derives health condition indicators; (iii) associates those indicators with structured cost and effect information; (iv) constructs machine-targeted prompt sentences for a generative AI model; (v) generates and refines natural-language recommendations for cost-optimized health-related expenditure; and (vi) securely stores and manages all intermediate and final data with integrated access control and encryption. Such a system should improve the technical functioning of the computer by defining concrete data flows, data structures, and processing steps that enable efficient, auditable, and adaptive generation of health-related recommendations, rather than merely automating a human mental process.

The specific processing by the specific processing unit 290 of the data processing device 12 in Application Example 1 is realized by the following means.

The present invention provides a server comprising a processor and a memory storing instructions, the instructions, when executed by the processor, causing the processor to receive biological information including genetic information from a user; convert the received biological information into feature data for analysis; estimate one or more indicators related to a health condition based on the feature data by using a statistical learning model; acquire supplementary information including cost information and effect information related to health resources, examination items, nutritional support resources, or medical products; generate, based on the indicators and the supplementary information, a structured prompt sentence for a generative AI model that encodes the indicators, the cost-effectiveness context, and user-specific constraints; cause the generative AI model, by inputting the prompt sentence, to generate information including natural-language explanatory content and a proposal for optimization of health-related expenditure; convert the explanatory content and the proposal into provision information in a format capable of being output to a user terminal; and store the biological information, the indicators, the supplementary information, the prompt sentence, and the provision information in a storage device with access control and encryption, together with metadata linking each stored record to one or more model versions and processing sessions. This enables improvement of the operation of a computer-implemented health recommendation system by defining specific data transformations and control flows that integrate predictive models, cost-effectiveness evaluation, and generative AI-based natural-language generation into a unified, privacy-preserving architecture, thereby allowing the computer system to automatically produce and iteratively refine personalized, cost-optimized health-related expenditure proposals in a technically efficient and auditable manner.

The term “biological information” refers to information representing one or more biological characteristics of a subject, including but not limited to genetic information, biochemical measurements, physiological measurements, and derived biological indicators, in any electronic data format.

The term “genetic information” refers to information representing one or more genetic variants, genotypes, alleles, or other nucleic acid sequence characteristics of a subject, including data obtained from genotyping, sequencing, or interpreted genetic reports.

The term “feature data” refers to data obtained by transforming biological information into a numerical or categorical representation suitable for input to a computational model, including vectors, tensors, or other structured data formats.

The term “statistical learning model” refers to a computational model trained on data to infer relationships between input feature data and output variables, including but not limited to machine learning models, deep learning models, regression models, and classification models executed by a processor.

The term “indicator related to a health condition” refers to a value, score, category, or label that represents an estimated risk, tendency, predisposition, or other characteristic of a subject's health state as inferred from feature data by a statistical learning model.

The term “supplementary information” refers to information other than the biological information and the indicators related to a health condition, including cost information, effect information, and other contextual information regarding health resources, examination items, nutritional support resources, or medical products.

The term “cost information” refers to information representing monetary cost or other resource expenditure associated with acquisition, use, or maintenance of a health resource, examination item, nutritional support resource, or medical product.

The term “effect information” refers to information representing an expected health effect, benefit, efficacy, or outcome associated with a health resource, examination item, nutritional support resource, or medical product.

The term “health resource” refers to any service, facility, or offering related to prevention, diagnosis, treatment, or management of a health condition, including but not limited to clinical visits, screening programs, and health monitoring services.

The term “examination item” refers to a diagnostic or screening procedure, laboratory test, imaging procedure, or similar examination that generates information about a subject's health state.

The term “nutritional support resource” refers to any product, service, or regimen intended to provide nutritional supplementation or dietary support, including dietary supplements, fortified foods, and organized nutrition programs.

The term “medical product” refers to a tangible item intended for use in the diagnosis, cure, mitigation, treatment, or prevention of disease, or intended to affect the structure or function of the body, including pharmaceuticals, therapeutic devices, and over-the-counter health products.

The term “generative AI model” refers to a computational model configured to generate output data, including natural-language text, in response to input data, by learning patterns from training data and producing novel content that is not limited to direct retrieval of stored records.

The term “prompt sentence” refers to a structured input, including text and optionally metadata, that is provided to a generative AI model to specify context, constraints, and desired output characteristics for generation of information.

The term “natural-language explanatory content” refers to text expressed in a human language that explains the indicators related to a health condition, their implications, and related information in a manner understandable to a human reader.

The term “proposal for optimization of health-related expenditure” refers to information that recommends one or more actions, selections, or configurations of health resources, examination items, nutritional support resources, or medical products in a way that is intended to improve cost-effectiveness while maintaining or improving expected health outcomes.

The term “provision information” refers to information formatted for output to a user terminal, including structured or unstructured data, text, and associated metadata suitable for display, storage, or further processing on the user terminal.

The term “user terminal” refers to an information processing device operated by or on behalf of a user, including but not limited to a mobile device, a portable computing device, a stationary computing device, or a web client, that is capable of communicating with the server.

The term “storage device” refers to any hardware or virtualized component configured to store data electronically, including volatile memory, non-volatile memory, magnetic storage, solid-state storage, or network-attached storage.

The term “access control” refers to a mechanism or set of mechanisms implemented by hardware or software to regulate which entities, processes, or users are permitted to access, modify, or use specific data or functions.

The term “encryption” refers to a process of transforming data using a cryptographic algorithm and one or more cryptographic keys so that the data is unintelligible to unauthorized parties and can be restored to intelligible form only by authorized parties.

The term “metadata” refers to data that describes properties, context, provenance, or relationships of other data, including but not limited to identifiers, timestamps, model version identifiers, and processing session identifiers.

The term “processing session” refers to a logically grouped set of operations performed by the server in response to one or more related requests, including receiving input data, executing models, generating outputs, and storing results, which can be identified and tracked as a unit.

The term “model version” refers to a specific state or configuration of a statistical learning model or a generative AI model, including its parameters, architecture, and associated training data reference, which distinguishes it from other states or configurations of the same model.

In one embodiment, the server includes at least one processor, a main memory, a non-volatile storage device, and a network interface. The server executes an operating system such as a general-purpose server operating system and executes application software implemented, for example, in a high-level programming language. The server further executes libraries for numerical computation and machine learning, such as a tensor computation framework and a deep learning framework, and executes a natural language processing framework implementing a generative AI model based on a neural network architecture.

The server stores, in the non-volatile storage device, program modules including a data ingestion module, a feature extraction module, a statistical learning module, a cost-effectiveness evaluation module, a prompt generation module, a generative AI interaction module, a post-processing module, and a data management module. The server also stores trained model parameters for a statistical learning model and for a generative AI model. The memory holds intermediate data structures, including biological information records, feature vectors, model outputs, cost tables, prompt sentences, and generated natural-language texts.

The terminal includes a processor, a memory, a display, an input device, a local storage unit, and a communication interface. The terminal executes an application program that provides a user interface for authentication, input of biological information, selection of user preferences, display of recommendation information, and transmission of instruction and feedback information to the server. The terminal can be implemented as a mobile information processing device, a portable information processing device, or a stationary information processing device. The terminal communicates with the server via a communication network using a secure communication protocol.

The user operates the terminal to input biological information including genetic information.

The user may upload a file representing genetic variants, for example a variant call format file or a structured report file, and may additionally input demographic attributes such as age range and sex, and preference parameters such as maximum monthly budget or avoidance of certain types of medical resources. The terminal transmits the biological information and the preference parameters to the server through the communication network, with appropriate authentication information.

The server receives the biological information and stores it in an internal representation. The server converts the biological information into feature data by parsing the input file, mapping variant identifiers to a predefined index space, and constructing fixed-length numerical vectors. The server uses a feature extraction module implemented with a numerical computation library to perform operations such as encoding genotypes into one-hot or dosage representations, normalizing continuous values, and imputing missing values with statistically derived defaults. By standardizing the feature data into a fixed-length tensor, the server enables efficient processing by the statistical learning model and efficient memory allocation and caching by the hardware.

The server applies a statistical learning model to the feature data. In one embodiment, the server uses a neural network including multiple layers, such as an input layer corresponding to the feature vector, one or more hidden layers such as fully connected layers with non-linear activation functions, and an output layer that produces one or more indicators related to a health condition. The server may also employ a mixture of linear and non-linear components, such as embedding layers for specific genetic loci, followed by aggregation layers and dense layers. The server computes forward propagation of the input tensor through the neural network, obtaining outputs such as risk scores for specific conditions, sensitivity scores for particular nutrients or drugs, and indices representing potential benefit of certain examination items.

The server can train or fine-tune the statistical learning model using historical data stored in the storage device. The server uses a supervised learning method with a loss function such as cross-entropy or mean squared error, and uses an optimization algorithm such as stochastic gradient descent or a variant thereof. During training, the server applies mini-batch processing, backpropagation, and weight updates, and may apply regularization techniques such as dropout or weight decay. The server may further perform data augmentation in the feature space, for example by simulating plausible genotype combinations within known linkage structures, to improve generalization and robustness. This training procedure allows the statistical learning model to efficiently exploit high-dimensional genetic feature data beyond human cognitive capacity, thereby improving prediction accuracy and enabling real-time inference.

The server acquires supplementary information from one or more data tables stored in the storage device. The supplementary information includes cost information, such as price ranges and reimbursement conditions for health resources, examination items, nutritional support resources, and medical products, as well as effect information such as expected effect sizes, typical outcome improvements, and adverse event probabilities. The server stores this supplementary information in normalized relational tables or key-value data structures, indexed by standardized identifiers for the corresponding resources. The server loads relevant entries based on the indicators related to the health condition, and constructs structured records that associate each indicator with a candidate action and its cost and effect attributes.

The server evaluates cost-effectiveness of potential health-related expenditures by applying algorithmic rules and, optionally, additional statistical models. The server can compute measures such as cost per unit of expected effect, rank candidate resources according to a multi-objective function that balances effect magnitude, cost level, and user preferences, and filter out options that violate constraints such as maximum budget or avoidance of certain resource types. By performing these computations on structured numeric representations, the server reduces the need to embed raw cost-related logic in natural-language templates, thereby decreasing the likelihood of inconsistent recommendations and enabling faster updates of cost parameters without retraining language components.

The server generates a prompt sentence for a generative AI model. The server constructs the prompt sentence by combining textual segments and structured data converted into textual form. For example, the server may generate a prompt sentence such as:

“User genetic summary: high likelihood of vitamin D deficiency due to observed variants; no elevated risk detected for calcium metabolism issues; moderate risk profile for cardiovascular disease. Cost context: budget is limited; prioritize cost-effective options and avoid expensive branded products when generic equivalents exist. Task: In plain English, explain the health implications and propose cost-effective actions, including dietary changes, over-the-counter supplements, and combined medical examinations, without making definitive medical diagnoses and while encouraging consultation with healthcare professionals.”

In another example, the server may generate a prompt sentence such as:

“Based on the following risk indicators and cost-effectiveness scores, generate a detailed recommendation: (1) vitamin D supplement: high benefit, low cost; (2) general blood panel including 25(OH)D: medium cost, high information value; (3) premium ‘DNA-tailored’ supplement package: low incremental benefit, high cost. Focus on options (1) and (2), and clearly explain why option (3) is not recommended from a cost-effectiveness perspective.”

The server includes, in the prompt sentence, explicit instructions regarding style, length, and coverage of content, and may include tokens or markers that correspond to internal identifiers of indicators and resources. This structured prompt design improves consistency between the numeric evaluation and the generated natural-language output, and enables the server to parse sections of the generated text back into structured references when performing post-processing.

The server transmits the prompt sentence to a generative AI model implemented on the same server or on a connected computation node. In one embodiment, the generative AI model is a neural language model using a transformer architecture, including an embedding layer, multiple self-attention layers, and a final projection layer to a token vocabulary. The generative AI model is trained on large-scale text data using an objective such as next-token prediction. The server provides the prompt sentence as an input sequence of tokens and receives a generated sequence of tokens as output. The server can configure decoding parameters, such as maximum number of tokens, temperature, nucleus sampling thresholds, and beam width, thereby controlling the trade-off between diversity and determinism.

The server integrates the generative AI model into the system in a way that improves computer-implemented processing. By separating numeric risk and cost computations from language generation, and by encoding intermediate results into structured prompt sentences, the server ensures that the generative AI model operates on a well-defined context rather than raw biological data. This reduces unnecessary tokenization and string processing overhead, which leads to reduced processor load and memory usage. In addition, because the generative AI model receives pre-aggregated, cost-weighted indicators, it can generate coherent recommendations without repeatedly performing reasoning over large external knowledge bases, thereby decreasing inference latency.

The server post-processes the generated natural-language explanatory content and the proposal for optimization of health-related expenditure. The server parses the generated text to detect potentially ambiguous or prohibited expressions, applies rule-based transformations to enforce regulatory phrases and disclaimers, and adapts formatting to the constraints of the terminal. The server may map specific segments of the text back to internal identifiers, for example by searching for labeled markers included in the prompt, which allows the server to verify that the generative AI output is consistent with the internal cost-effectiveness rankings. If inconsistencies are detected, the server can modify or annotate the text, such as inserting clarifying sentences or replacing suggested products with equivalent generic resources.

The server stores, in the storage device, the biological information, feature data, indicators related to the health condition, supplementary information references, prompt sentences, generated texts, and associated metadata. The server applies access control by assigning roles and permissions to user identifiers and process identifiers, and applies encryption to stored records and communication channels. The server links each record to model version identifiers and processing session identifiers. This linkage enables the server to reproduce or audit any given recommendation by re-executing the same sequence of model inferences and prompt generation steps, which is critical for reliability in safety-critical contexts.

The terminal receives the provision information from the server and displays it to the user.

The terminal converts the provision information into viewable elements such as headings, paragraphs, lists, and links, and may provide interactive controls for the user to request alternative scenarios, such as a diet-only plan, a minimal-cost plan, or a plan prioritizing non-pharmaceutical interventions. The user can input instruction information and feedback information through the terminal, such as marking certain recommendations as unsuitable or requesting more detail on a particular resource. The terminal transmits this information to the server as structured messages.

The server receives the instruction information and feedback information and reconstructs the prompt sentence accordingly. For example, the server may modify the prompt sentence to read:

“Refine the previous advice to focus only on dietary changes and low-cost lifestyle adjustments. Do not recommend any supplements or medical examinations. Explain why these changes are particularly relevant given the user's genetic risk profile.”

Alternatively, the server may generate a prompt sentence such as:

“Based on user feedback, provide an alternative plan that further reduces monthly expenses by 30% while maintaining as much expected health benefit as possible. Clearly state which recommendations are removed or downgraded compared to the previous plan and provide a brief justification.”

By incorporating structured feedback into the prompt sentence, the server enables the generative AI model to generate new recommendations aligned with updated constraints while reusing previously computed indicators and cost-effectiveness evaluations. The server does not reprocess the raw biological information unless necessary, which reduces processing time and server load. This incremental generation and refinement mechanism constitutes a non-conventional processing pattern that improves computational efficiency and reduces network traffic, because smaller messages and fewer model inferences are required to accommodate user-driven changes.

In another embodiment, the server may execute the generative AI model on a separate hardware accelerator, such as a graphics processing unit or a tensor processing unit, while running the statistical learning model on a different accelerator or central processing unit. The server schedules jobs between these components, minimizing idle time and balancing throughput. For example, the server can batch multiple prompt sentences for concurrent inference by the generative AI model and can batch multiple feature vectors for concurrent inference by the statistical learning model. This hardware-aware scheduling improves overall system throughput and reduces latency for individual users, particularly in scenarios with high request volumes.

The system as described provides technical effects that go beyond mere automation of human judgment. The server implements specific data structures for genetic feature data, cost and effect tables, prompt sentences, and generated texts, and implements defined computational graphs for statistical learning and generative modeling. By systematically transforming raw biological information into feature data, mapping the feature data to indicators via a trained neural network, combining the indicators with structured cost and effect information, encoding the combined information into a compact, instruction-rich prompt sentence, and using a transformer-based generative AI model configured with specific decoding settings, the server improves prediction accuracy, reduces processing time, and enhances consistency of the generated recommendations. The integration of access control, encryption, and model version tracking into the core data flow further improves the reliability and traceability of computer-implemented processing.

The system can be varied in multiple ways. In one variant, the statistical learning model may be an ensemble of models, such as a combination of gradient-boosted decision trees and neural networks, and the server can aggregate their outputs via weighted averaging or stacking. In another variant, the generative AI model may be fine-tuned on domain-specific texts, and the server may store separate model versions for different languages or regulatory regions. In yet another variant, the cost-effectiveness evaluation may incorporate simulation of long-term outcomes via a Markov model or other probabilistic model, with the server computing expected lifetime costs and benefits and embedding summary figures into the prompt sentence. In all such variants, the server, the terminal, and the user interact according to the same overarching architecture, and the technical improvements in data processing, resource utilization, and recommendation quality are preserved.

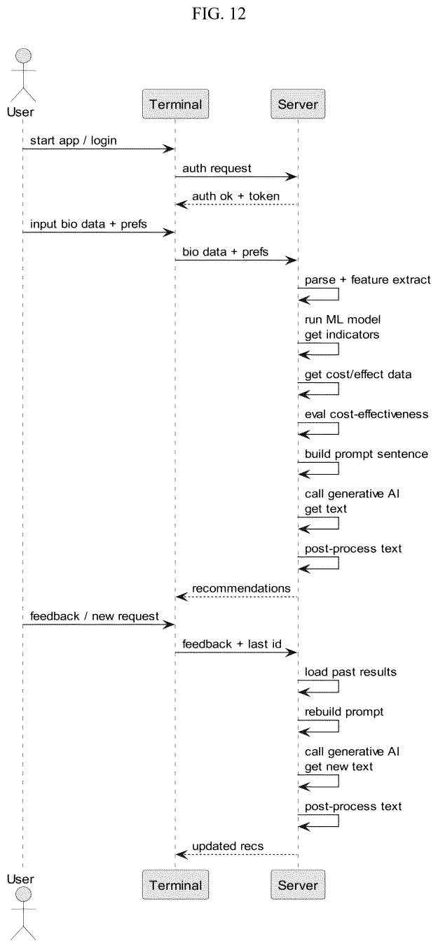

The following describes the processing flow using FIG. 12.

### Step 1:

The user operates the terminal to launch an application and authenticate.

The terminal receives user credentials and consent information as input, displays input fields, and packages the credentials and consent flags into an authentication request.

The terminal sends the authentication request to the server as output.

### Step 2:

The server receives the authentication request as input, verifies the credentials against user records stored in a storage device, and checks the consent flags.

The server performs data lookup and comparison operations, generates a session token if authentication succeeds, and associates the token with a user identifier in memory.

The server sends the session token and an authentication result to the terminal as output.

### Step 3:

The terminal receives the session token as input and stores the token in a secure local storage area.

The terminal then requests a biological information input screen from the server by sending a screen-request message that includes the session token as output.

### Step 4:

The server receives the screen-request message as input and verifies the session token.

The server generates a screen definition including fields for uploading biological information (such as genetic data files) and inputting user preferences, by constructing a structured description of form elements.

The server sends the screen definition to the terminal as output.

### Step 5:

The terminal receives the screen definition as input and renders an input screen using a user interface framework.

The terminal displays controls for file selection, text entry, and preference selection, and waits for user interaction.

The terminal outputs the rendered screen to the display for the user.

### Step 6:

The user operates the terminal to select or capture biological information and to input preference parameters.

The terminal receives a biological information file and user preferences (such as budget constraints and resource constraints) as input from the user.

The terminal performs local validation on file size and format, attaches metadata such as file name and approximate collection date, and sends a biological-information submission request including the session token to the server as output.

### Step 7:

The server receives the biological-information submission request as input and verifies the session token and basic file properties.

The server stores the raw biological information file in a secure storage location, creates a database record that links the stored file to the user identifier, and loads the file into memory.

The server outputs a parsed internal representation of the raw biological information for further processing.

### Step 8:

The server receives the parsed internal representation of the biological information as input and executes a feature extraction module.

The server maps identifiers (such as variant IDs) to indices in a predefined feature index table, encodes each observed attribute (such as genotype or allele dosage) into numeric values, handles missing values with default or imputed values, and normalizes numeric ranges.

The server outputs a fixed-length feature vector or tensor that is suitable as input to a statistical learning model.

### Step 9:

The server receives the feature vector as input to a statistical learning model stored in memory.

The server performs a forward pass through a trained neural network or other statistical learning model, computing weighted sums and activation functions layer by layer to generate outputs such as risk scores and sensitivity scores.

The server outputs a set of indicators related to health conditions, each indicator including a numeric score and, optionally, a categorical label.

### Step 10:

The server receives the indicators related to health conditions as input and queries supplementary information tables stored in a storage device.

The server retrieves cost information and effect information for health resources, examination items, nutritional support resources, and medical products that are relevant to the indicators.

The server outputs a collection of candidate actions, each associated with cost attributes, effect attributes, and a link to one or more health indicators.

### Step 11:

The server receives the candidate actions with associated attributes as input and executes a cost-effectiveness evaluation module.

The server computes evaluation metrics such as cost per unit of expected benefit, ranks the candidate actions according to a multi-criteria function that incorporates user preferences, and filters out actions that violate given constraints such as maximum budget or avoidance of certain resource types.

The server outputs a ranked and filtered list of recommended actions with cost-effectiveness scores.

### Step 12:

The server receives the ranked and filtered list of recommended actions and the indicators related to health conditions as input and constructs a prompt sentence for a generative AI model.

The server generates text segments that summarize the health indicators, expresses the cost context and user preferences, and describes which candidate actions should be highlighted or downplayed, then concatenates these segments into a single natural-language prompt sentence.

The server outputs the constructed prompt sentence.

### Step 13:

The server supplies the prompt sentence as input to a generative AI model implemented, for example, as a transformer-based language model.

The server tokenizes the prompt sentence, feeds the token sequence into the generative AI model, and configures generation parameters such as maximum token length and sampling settings.

The server outputs a generated token sequence, which it decodes into natural-language explanatory content and a proposal for optimization of health-related expenditure.

### Step 14:

The server receives the generated explanatory content and proposal as input to a post-processing module.

The server performs text processing operations such as trimming overly long sections, inserting standard disclaimers, checking for prohibited phrases, and, if necessary, editing or annotating parts of the text to align with internal cost-effectiveness rankings and regulatory constraints.

The server outputs finalized natural-language texts suitable for presentation to the user.

### Step 15:

The server receives the finalized explanatory content and proposal as input and converts them into provision information in a structured response format.

The server adds metadata such as identifiers for the health indicators, recommended actions, model versions, and processing session, and packages the data into a response message addressed to the terminal.

The server sends the provision information to the terminal as output.

### Step 16:

The terminal receives the provision information as input from the server.

The terminal parses the structured data, maps textual sections to user interface elements, and generates a display layout that includes headings, paragraphs, and interactive controls (for example, buttons to request alternative plans).

The terminal outputs the rendered recommendation screen to the user on the display.

### Step 17:

The user reads the displayed recommendations and, if desired, provides instruction information or feedback information through the terminal.

The terminal receives the user's inputs as input data, including selections such as “focus on diet only,” “reduce monthly cost,” or “not interested in specific recommendations.”

The terminal constructs a feedback request message that includes the previous recommendation identifier, the instruction information, and the feedback information, and sends this message to the server as output.

### Step 18:

The server receives the feedback request message as input and retrieves the previous indicators, candidate actions, and cost-effectiveness evaluations from the storage device using the included identifier.

The server incorporates the instruction information and feedback information into a modified context, updates ranking or filtering if necessary, and generates a revised prompt sentence that explicitly reflects the user's new constraints and preferences.

The server outputs the revised prompt sentence and then repeats the generative AI interaction and post-processing steps to produce an alternative or modified recommendation for the user.

It is also possible to incorporate an emotion engine for estimating the user's emotions. That is, the specific processing unit 290 may estimate the user's emotions using an emotion identification model 59, and perform specific processing based on the estimated emotions.

### EXAMPLE 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information processing systems that provide medical or biological insights from user biological information, such as genomic profiles, typically rely on static rule sets, manually curated knowledge bases, or pre-defined query templates. These systems suffer from multiple technical limitations. First, such systems are not well suited for processing large volumes of heterogeneous research information continuously generated from multiple networked information sources. As a result, the systems often fail to keep pace with the latest research information, leading to outdated or incomplete outputs. Second, when these systems attempt to incorporate unstructured research information, they usually perform only simple keyword searches or pattern matching, which produces noisy and ambiguous results that require substantial manual post-processing. This leads to high computational overhead, inefficient memory usage, and poor scalability when the volume of research information grows.

Third, when generative AI models are used in a naive manner, the systems typically send unstructured text as input and receive unstructured text as output, without integrating explicit control over the prompt sentences or structured intermediate representations. This results in outputs that are difficult to validate, difficult to map back to specific biological information of a particular user, and difficult to reuse in downstream computations. In other words, the generative AI models operate as black boxes, which degrades the reliability, traceability, and machine-interpretability of the generated information within the overall computing architecture.

Fourth, existing systems often treat user-facing explanatory information as a mere presentation layer, rather than as a product of a controlled, repeatable, and machine-assisted generation pipeline. This results in duplication of processing, ad hoc formatting, and inconsistent handling of user-level explanations. Furthermore, conventional systems tend to implement encryption and access control as separate layers that are not tightly integrated with the data processing pipeline for biological information and research information, thus complicating the design of secure and auditable workflows.

Accordingly, there is a need for a technical solution that improves the functioning of a computer system by: (i) efficiently acquiring and preprocessing research information from distributed information sources over a communication network; (ii) transforming the research information into structured data using natural language processing and controlled prompt sentences for a generative AI model; (iii) systematically matching analysis results produced by the generative AI model to user biological information; and (iv) generating non-expert user-oriented explanatory information in a way that is reproducible, traceable, and integrated with encryption and access control. Such a solution should reduce computational redundancy, improve the accuracy and consistency of the generated outputs, and enable scalable and privacy-preserving information processing beyond what is achievable with conventional rule-based or ad hoc generative systems.

The specific processing by the specific processing unit 290 of the data processing device 12 in Example 2 is realized by the following means.

The present invention provides a server comprising a processor and a memory storing instructions that, when executed by the processor, cause the processor to receive biological information from a user terminal via a communication network and store the biological information in a storage area; to acquire research information automatically from one or more information sources via the communication network and store the research information in the storage area; to perform preprocessing on the research information by using natural language processing to extract information elements including target factors, treatment contents, and outcome contents from the research information and to generate structured data including the extracted information elements; to generate, based on the biological information and the structured data, a first prompt sentence including an analysis request for a generative information processing apparatus, to transmit the first prompt sentence and at least a portion of the research information to the generative information processing apparatus, and to obtain an analysis result associated with the structured data from the generative information processing apparatus; to compare information elements relating to the target factors included in the analysis result with the biological information and to extract or aggregate useful information corresponding to the biological information to generate a technical report; to generate, based on the useful information included in the technical report, a second prompt sentence requesting creation of non-expert user-oriented explanatory information for the generative information processing apparatus, to transmit the second prompt sentence and the useful information to the generative information processing apparatus, and to obtain the non-expert user-oriented explanatory information from the generative information processing apparatus; to transmit the non-expert user-oriented explanatory information to the user terminal so that the user terminal presents the non-expert user-oriented explanatory information as notification information and display information; and to perform encryption processing and access control processing on at least the biological information, the research information, the structured data, the analysis result, and the non-expert user-oriented explanatory information stored in the storage area. This enables a computer-centric improvement in that the server systematically converts unstructured research information into structured intermediate representations, orchestrates controlled prompt sentences for a generative AI model to obtain machine-usable analysis results, efficiently matches the analysis results to user-specific biological information, and generates traceable, privacy-preserving explanatory information for non-expert users, thereby enhancing processing efficiency, scalability, and reliability of the overall information processing pipeline beyond conventional rule-based or ad hoc generative systems.

The term “biological information” refers to information representing a characteristic of a living subject, including but not limited to genetic information, genomic sequence information, variant information, clinical attribute information, and phenotypic attribute information, which is processable by a computing apparatus.

The term “user” refers to an individual or an entity that provides biological information to the system and receives information generated by the system, and may include, for example, a patient, a healthcare professional, or an operator of a terminal device.

The term “user terminal” refers to an information processing device operated by a user, such as a portable terminal, a stationary terminal, or a general-purpose computing device, which is configured to transmit biological information to a server and to receive and present information from the server.

The term “research information” refers to information obtained from an external information source via a communication network, the information including at least one of scientific literature, academic reports, clinical study summaries, and database records relating to biological phenomena, treatments, or outcomes.

The term “information source” refers to an external system, service, or storage apparatus accessible via a communication network, which provides research information, such as a literature database system, a publication distribution system, or a knowledge database system.

The term “communication network” refers to a wired or wireless data communication infrastructure, including one or more of the Internet, a local area network, a wide area network, a cellular network, or any combination thereof, through which data is exchanged between a user terminal, a server, and an information source.

The term “storage area” refers to a logical or physical memory region provided by one or more storage devices, such as a semiconductor memory, a magnetic storage device, or an optical storage device, in which biological information, research information, structured data, analysis results, and explanatory information are stored.

The term “natural language processing” refers to a computational technique for analyzing and processing text or speech expressed in a natural language, the technique including at least one of tokenization, part-of-speech tagging, syntactic parsing, entity extraction, sentence segmentation, or semantic analysis.

The term “information element” refers to a unit of information extracted from research information or analysis results, the unit representing a specific semantic category such as a target factor, a treatment content, or an outcome content.

The term “target factor” refers to a subject of analysis relating to biological information, such as a gene, a genetic variant, a biomarker, a molecular target, or another biological characteristic, that is identified within research information or analysis results.

The term “treatment content” refers to information describing an intervention or action applied to a subject, including but not limited to administration of a pharmaceutical agent, a therapeutic procedure, a preventive measure, or a lifestyle modification.

The term “outcome content” refers to information describing a result or effect of a treatment content or a condition associated with a target factor, including but not limited to clinical outcomes, risk levels, response rates, prognostic indicators, or adverse events.

The term “structured data” refers to data arranged according to a predefined schema or format, such as a record, a table, or a tagged data structure, in which information elements including target factors, treatment contents, and outcome contents are explicitly represented and machine-readable.

The term “generative information processing apparatus” refers to a hardware or software system configured to receive a prompt sentence as input and generate output information by using a generative AI model, such as a probabilistic model or a neural network model trained on natural language data.

The term “generative AI model” refers to a computational model configured to generate text or other data based on input information, by predicting sequences of symbols or tokens using learned parameters, and which may be implemented as, for example, a language model or a transformer model.

The term “prompt sentence” refers to a text or data string provided as input to a generative information processing apparatus, the text or data string specifying at least one of an analysis request, a generation request, a format constraint, or a role instruction for the generative AI model.

The term “analysis result” refers to information generated by the generative information processing apparatus in response to a prompt sentence requesting analysis, the information including at least one of extracted information elements, inferred relationships, or summarized findings associated with research information or biological information.

The term “useful information” refers to information derived by comparing analysis results with biological information, the information being evaluated as relevant to a particular user or biological condition and including at least one of risk-related information, treatment-related information, or recommendation-related information in technical form.

The term “technical report” refers to an internal representation of useful information organized for machine processing, the representation including at least structured data describing target factors, treatment contents, outcome contents, and associated research sources.

The term “non-expert user-oriented explanatory information” refers to information generated for presentation to a user who does not possess specialized technical knowledge, the information being derived from useful information or a technical report and expressed in natural language with reduced technical complexity.

The term “notification information” refers to information used to alert a user via a user terminal about the availability, update, or presence of non-expert user-oriented explanatory information, such as a message displayed as a push notification or alert.

The term “display information” refers to information presented on a screen or display unit of a user terminal, including the content of non-expert user-oriented explanatory information and optionally associated user interface elements.

The term “encryption processing” refers to a computational operation that transforms data such that the data is converted into an unintelligible form for unauthorized entities, using an encryption algorithm and one or more keys, to protect confidentiality of biological information, research information, and related data.

The term “access control processing” refers to a computational mechanism that manages permission to access data or functions, including authentication and authorization procedures, such that only entities with appropriate privileges can read, modify, or transmit biological information, research information, structured data, analysis results, or explanatory information.

The term “processor” refers to a hardware computation unit or group of units, such as a central processing unit, a microcontroller, or a processing core, configured to execute instructions and perform arithmetic or logical operations needed to implement the functions of the system.

The term “memory” refers to a hardware component or combination of components for storing instructions and data used by the processor, including volatile memory and non-volatile memory.

The term “server” refers to a computing apparatus or a group of computing apparatuses that includes at least one processor and at least one memory, and that is configured to communicate with a user terminal and an information source via a communication network to execute at least part of the processing defined in the claims.

In one embodiment, a server, a terminal, and a user cooperate to implement the claimed system. The server includes at least one processor, at least one memory, a network interface, and one or more storage devices. The terminal includes at least one processor, a memory, a display unit, an input unit, and a network interface. The user operates the terminal to provide biological information and to receive explanatory information. The server executes a plurality of software modules to perform acquisition, analysis, matching, and presentation of information based on a generative AI model and controlled prompt sentences. The server uses commodity hardware such as an x86-64 central processing unit, a graphics processing unit configured for machine learning workloads (for example, a general-purpose GPU supporting CUDA or an equivalent parallel computing framework), semiconductor main memory, and a nonvolatile storage device such as a solid-state drive. The server runs an operating system such as a general-purpose server operating system. The server executes application software implemented using a server-side framework such as a web application framework (for example, a Python-based framework or a similar framework), a natural language processing library (for example, a tokenization and entity recognition toolkit), and a database management system such as a relational database system. The server further accesses a generative AI model that is implemented as a transformer-based neural network executed either locally on the GPU or remotely via an external model-serving environment. The terminal executes an application, such as a native application on a portable device or a web application within a browser. The terminal presents a user interface that allows the user to input biological information, including genetic variants or other biological attributes, and to view explanatory information. The terminal communicates with the server via a communication network using secure transport protocols to transmit data and receive responses.

The server uses the memory to store program instructions and data structures including, but not limited to, a biological information table, a research information repository, a structured data repository, an analysis result repository, and a user report repository. Each repository uses a specific data schema. For example, the biological information table stores, per user, records including user identifiers, gene identifiers, variant identifiers in a standardized notation, and associated metadata such as confidence scores. The research information repository stores structured representations of external research information, including article identifiers, titles, abstracts, and extracted entities. The structured data repository stores data structures that represent target factors, treatment contents, and outcome contents in a normalized form. The analysis result repository stores outputs produced by the generative AI model, and the user report repository stores technical reports and non-expert user-oriented explanatory texts.

The server uses a natural language processing library to perform tokenization, sentence segmentation, part-of-speech tagging, and named entity recognition for incoming research information. The server implements an entity extraction model that uses a bi-directional recurrent neural network or a transformer encoder trained on biomedical corpora. The server thereby extracts mentions of genes, variants, treatments, and outcomes from unstructured text. The server normalizes the extracted entities into canonical forms by applying rule-based mappings and reference dictionaries stored in the memory. For example, the server maps variant descriptions given in different notation styles into a common notation.

The server accesses a generative AI model that is implemented as a multi-layer transformer network with self-attention mechanisms. In one embodiment, the generative AI model includes an embedding layer that maps discrete tokens into continuous vector representations, a stack of transformer blocks each including multi-head self-attention and position-wise feed-forward networks, and an output layer that generates token probabilities for the next token in a sequence. The server configures the generative AI model with parameters such as a number of layers, a number of attention heads, a hidden dimension size, and vocabulary size. The generative AI model has been trained, prior to deployment, on a large corpus of natural language text including biomedical literature and general language corpora.

The server, during training of the generative AI model or a fine-tuned variant thereof, uses supervised learning and gradient-based optimization. The server defines a loss function such as cross-entropy between predicted token distributions and target tokens. The server updates the model parameters according to an optimization algorithm such as stochastic gradient descent or an adaptive optimization method. The server stores the learned parameters in the memory or in a storage device. The server may employ regularization techniques such as dropout and layer normalization in each transformer block to improve generalization performance. The server may also perform data augmentation techniques such as synonym replacement, sentence shuffling within an abstract, or prompt paraphrasing to improve robustness of the model to different prompt formulations.

The server does not simply employ the generative AI model as a black box. Instead, the server constructs prompt sentences according to pre-defined templates that include explicit structure and constraints. The server includes in each prompt sentence specific instructions regarding the type of output required (for example, a list of variants, treatments, and outcomes) and the format of the output. The server thereby converts loosely structured natural language research information into machine-usable structured data without relying on purely manual rules.

In one embodiment, the server generates a prompt sentence to extract variant-related information from a single research abstract. The server constructs a text string such as:
“Article title: [title text]
Journal: [journal name], Year: [year value]
Abstract: [abstract text]
Task:
1. Identify all specific gene variants (for example, ‘BRCA 1c.5266 dupC’, ‘BRCA 2 c.5946delT’, ‘EGFR exon 19 deletion’) mentioned or clearly implied in this abstract.
2. For each identified variant, describe in technical terms:
   The associated disease or condition.
   The described treatment or intervention (if any).
   The reported clinical outcome (for example, response rate, risk increase, survival benefit).
3. Provide the answer in a consistent, structured textual format.”

The server then tokenizes this prompt sentence and supplies the tokens to the generative AI model. The generative AI model processes the tokens through its transformer layers, computing attention scores between tokens, updating internal representations, and outputting token probabilities step by step. The server decodes the output tokens using a decoding strategy such as greedy decoding or beam search, generating a coherent answer that includes variant names, associated diseases, treatments, and outcomes. The server then applies pattern matching and parsing rules to this answer to identify information elements and to populate the structured data repository. This explicit creation and reuse of structured intermediate representations improves the reliability and traceability of the outputs.

The server, by using structured intermediate representations, can efficiently match analysis results to user biological information. The server uses indexed data structures in the database to support fast lookups by gene identifier and variant identifier. Because the server has transformed unstructured text into standardized variant identifiers and treatment descriptors, the server can perform exact or near-exact joins between the biological information table and the structured data repository. This reduces computational complexity compared to naive full-text search and manual mapping. The server can also maintain versioned records of structured data to support auditing and reproducibility.

The server also generates prompt sentences for transforming technical information into non-expert user-oriented explanatory information. In one embodiment, the server constructs a prompt sentence such as:

“You are a medical genetics expert. You will receive a technical summary of gene variants and related clinical research for a specific person.

Your tasks are:
1. Explain each gene variant and its known or suspected health risks in clear, non-technical language that a general reader can understand.
2. Summarize related treatments, such as targeted medicines, and describe potential benefits and common side effects in general terms.
3. Emphasize that the information is educational only and that treatment decisions must be made with a qualified professional.
4. Organize the explanation with headings: ‘Your Gene Variant’, ‘What Research Says’, ‘Possible Treatment Options’, and ‘Important Notes’.
5. Keep the total length under 1,000 words.

Technical summary:

[technical summary text]”

The server again tokenizes this prompt sentence and processes it with the generative AI model. The generative AI model derives an internal representation that combines the semantic content of the technical summary with the user-friendly constraints described in the instructions. The server decodes the resulting token sequence into a natural language explanation. The server stores this explanation in the user report repository and associates it with the corresponding user and biological information.

The terminal retrieves the non-expert user-oriented explanatory information from the server and displays it to the user. The terminal may display the information in multiple views, such as a summary view and a detail view, and may allow the user to scroll, search within the explanation, and open links to underlying research articles. The terminal may also present notification messages. For example, the server may instruct the terminal to present a message such as:

“New research related to your gene variant profile has been identified. A summary of potential health risks and treatment options is now available. Please review the details.”

The terminal receives such notification, renders it in the notification area of the device, and, upon user interaction, retrieves the full explanation.

The server performs encryption processing and access control processing at multiple layers.

The server uses a cryptographic library to apply a symmetric encryption algorithm such as an advanced encryption standard to data stored in the storage devices. The server also uses transport-level encryption when communicating with the terminal and external information sources. The server enforces access control by storing a set of access policies in the memory and by evaluating access requests against those policies. The server may implement role-based access control, such that only authorized roles can read or modify biological information, structured data, and explanatory texts. The server maintains an audit log in the storage device, recording events such as data access, data modification, prompt generation, and model invocation. The server uses this log to verify system integrity and to support compliance with data protection regulations.

The server implements a pipeline architecture for managing data flow between modules. The server defines modules including a data acquisition module, a natural language processing module, a prompt generation module, a generative model interface module, a matching module, and a presentation module. Each module uses well-defined data structures to exchange information with other modules. The server schedules execution of these modules in a way that minimizes redundant computations. For example, the server performs natural language preprocessing once per research article and reuses the resulting structured data for multiple users whose biological information overlaps with the content of the article. This reduces processing time and computational resource consumption when additional users are added to the system.

The server benefits from technical effects that go beyond human mental processing or mere automation of human tasks. The server, by controlling the generative AI model with explicit prompt sentences and by introducing structured intermediate representations, reduces ambiguity and error rates in mapping from unstructured research information to user-specific outputs. The server can handle volumes of research information that exceed human capacity and can maintain up-to-date mappings as new articles become available. The server also improves computing efficiency by decomposing the processing into reusable stages, leveraging database indexing, and minimizing repeated analysis. The server reduces communication load by transmitting only aggregated and user-relevant information to the terminal, rather than raw research text.

In one embodiment, the server fine-tunes the generative AI model for the specific tasks of variant extraction and explanation generation. The server assembles a training dataset including pairs of prompts and target outputs. For variant extraction, the server uses human-annotated abstracts in which gene variants, treatments, and outcomes are labeled. For explanation generation, the server uses pairs of technical summaries and corresponding plain-language explanations. The server defines a loss function for each task and performs gradient-based updates to adapt the model weights. The server may share part of the transformer layers across tasks while using task-specific output heads, improving parameter efficiency and enabling multi-task learning. The server stores the fine-tuned model version identifiers and associates them with the prompts and outputs to support reproducibility.

In another embodiment, the server employs a rule-based post-processing module that validates and corrects the outputs of the generative AI model. The server defines consistency rules such as allowable ranges of values, valid gene name formats, and whitelists of known variant identifiers. The server applies these rules to the model outputs and flags any inconsistencies. The server may, for example, correct minor variations in gene symbols or discard outputs that do not match any recognized gene or variant. This non-conventional combination of generative modeling with deterministic rule checking enhances technical reliability and reduces propagation of model errors.

In another embodiment, the server uses a caching mechanism to store intermediate results of prompt executions. When the server receives a new request that matches a previous prompt and input context, the server retrieves the cached output instead of re-invoking the generative AI model. The server thereby reduces latency and computational load. The server may also use a similarity metric between new prompts and stored prompts to reuse near-identical outputs where appropriate. The server stores the similarity metrics and thresholds in the memory and can adjust them based on observed performance.

In another embodiment, the server deploys multiple generative AI models specialized for different subtasks. A first model may be optimized for extraction of structured information from research texts, whereas a second model may be optimized for producing user-oriented explanations. The server selects an appropriate model based on the prompt type and routes requests accordingly. This modularization allows the server to independently update or replace individual models without disrupting the entire system and contributes to improved maintainability and scalability.

In yet another embodiment, the server uses a distributed deployment architecture where multiple physical servers share the workload of generative model inference, data preprocessing, and database queries. The server assigns computational tasks based on current load, model size, and network latency, thereby optimizing overall system performance. The server monitors performance metrics such as processing time per request, memory utilization, and inference error rates, and may adapt configuration parameters to maintain service quality.

The terminal may be implemented in various forms, including a portable device, a tablet device, or a desktop device. The terminal may include a secure element or a trusted execution environment to store authentication tokens and to verify integrity of application code. The terminal may perform local validation of data received from the server and provide user settings for controlling notification preferences and privacy options.

The described embodiments demonstrate that the system is not limited to abstract data manipulation. Rather, the system implements a specific improvement to computer technology by defining a new pipeline that combines natural language processing, structured data transformation, controlled prompt sentence design, and generative AI model interaction. The server derives technical advantages in processing efficiency, accuracy, and scalability by orchestrating these components in a nonconventional way that is tied to the limitations of computing resources and network communication. The server thereby enables robust, privacy-preserving delivery of dynamically updated explanatory information that would be infeasible or impractical to produce manually or using conventional rule-based systems.

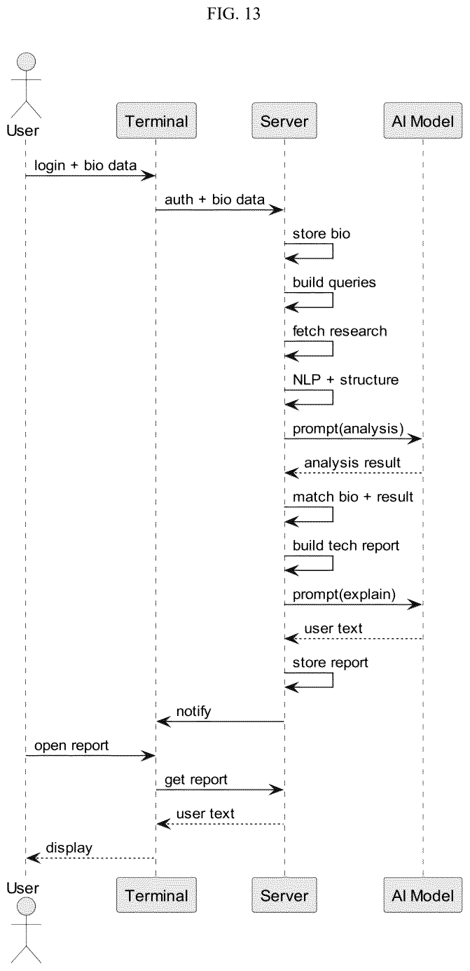

The following describes the processing flow using FIG. 13.

### Step 1:

The terminal displays a login or identification screen and receives user credentials or identification data from the user.

The terminal sends the credentials or identification data to the server via a secure communication protocol as an authentication request.

The server receives the authentication request as input, verifies the credentials against user records stored in a database, and, when authentication is successful, generates a session token as output.

The server returns the session token to the terminal, and the terminal stores the session token in a secure storage area and attaches the session token to subsequent requests as an authorization header.

### Step 2:

The terminal displays a biological information input screen including a file upload interface and text input fields.

The user selects a biological data file (for example, a genetic variant file) or manually enters variant identifiers and other biological attributes.

The terminal generates a data payload including the selected file and the entered text, and sends the payload together with the session token to the server.

The server receives the raw biological information as input, validates the file format and text fields, parses the biological records, and converts them into normalized internal representations (for example, standardized gene identifiers and variant notations).

The server stores the normalized biological information as output in a biological information table in a database and associates it with a user identifier.

### Step 3:

The server determines one or more relevant query terms based on the stored biological information.

The server generates search queries including gene identifiers, variant identifiers, and disease-related keywords, and sends the search queries to multiple external information sources via a communication network.

The external information sources return research information as input to the server, including at least metadata and unstructured text such as abstracts.

The server parses the received research information, extracts relevant fields, and stores the parsed research information as output in a research information repository in a storage device.

### Step 4:

The server retrieves newly stored research information records from the research information repository as input.

The server applies natural language processing operations, including tokenization, sentence splitting, and entity recognition, to each piece of research text.

The server identifies and extracts candidate target factors, treatment contents, and outcome contents from the token sequences and labels them as discrete information elements.

The server constructs structured data records that aggregate the extracted information elements in a normalized schema and stores the structured data records as output in a structured data repository.

### Step 5:

The server takes as input the structured data and the corresponding raw research text for one or more research records.

The server generates a first prompt sentence for a generative AI model by embedding the research title, abstract, and instructions into a single text sequence.

The server constructs the prompt sentence so that it explicitly requests identification of variants, treatments, and outcomes, and defines a desired structure of the response.

The server sends the prompt sentence to the generative AI model through a model interface and receives a generated response as output, the response including textual descriptions of variants, treatments, and outcomes inferred from the research information.

### Step 6:

The server receives the generated response from the generative AI model as input and parses the response according to predefined patterns or delimiters.

The server identifies variant names, treatment descriptions, and outcome descriptions within the response and converts them into machine-usable entries aligned with the structured data schema.

The server matches the content of the generated response with the structured data that was initially passed to construct the prompt sentence, and updates or extends the structured data records with refined or additional information.

The server stores the augmented structured data and the association between the prompt sentence and the generative AI model's response as output in the structured data repository and in an analysis result repository.

### Step 7:

The server retrieves, as input, the normalized biological information from the biological information table and the augmented structured data from the structured data repository.

The server performs a matching operation in which it compares gene identifiers and variant identifiers from the biological information with those contained in the structured data records.

The server applies exact and approximate matching rules, such as normalization of variant notation and gene synonyms, to determine which structured data records are relevant to a specific user's biological information.

The server aggregates all relevant structured data into a technical report object, organizing it by biological feature, associated treatment content, and outcome content, and stores the technical report object as output in a user report repository.

### Step 8:

The server takes the technical report object as input and prepares a second prompt sentence intended to generate non-expert user-oriented explanatory information.

The server embeds the technical content of the report into the prompt sentence together with instructions about style, length, and structure of the desired explanation.

The server sends the second prompt sentence to the generative AI model and receives a generated explanation text as output, the explanation being adapted for non-expert understanding.

The server stores the generated explanation text in association with the corresponding technical report and user identifier in the user report repository.

### Step 9:

The server determines, based on creation or update timestamps in the user report repository, that new non-expert user-oriented explanatory information is available for a particular user.

The server composes a notification message text indicating that new information has been generated, and sends the notification message together with a reference to the corresponding report to the terminal via a push notification mechanism.

The terminal receives the notification as input and displays it in a notification area or as an in-application alert.

The user selects or taps the notification, and the terminal sends a report retrieval request including the session token and the report reference to the server.

### Step 10:

The server receives the report retrieval request as input and verifies the session token and access rights of the requesting user.

The server retrieves the corresponding non-expert user-oriented explanatory information and related metadata from the user report repository as output.

The server sends the explanatory information and metadata to the terminal in a response message.

The terminal receives the explanatory information as input, renders it on a display unit by dividing it into sections such as variant overview, research summary, and treatment overview, and allows the user to scroll, read, and interact with the content.

### Step 11:

The server applies encryption processing to the biological information, the research information, the structured data, the analysis results, and the explanatory information before storing them in the storage devices.

The server maintains cryptographic keys in a secure key management component and uses them as input to cryptographic algorithms when encrypting and decrypting records.

The server enforces access control by evaluating user identities, roles, and session tokens as input against access policies stored in an access control list.

The server outputs only authorized data to the terminal and logs each access event in an audit log, thereby providing a traceable and secure data management environment.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer systems that provide genetic or biological counseling content typically treat large-scale biological data as static input and return pre-scripted, generic explanations. Such systems suffer from several technical limitations. First, they do not tightly integrate secure encryption, structured storage, and retrieval of sensitive biological information with automated generation of queries to a generative AI model. As a result, prompt construction is often performed manually or with simple templates at the application layer, leading to fragmented data flows, duplicated processing, and increased latency when assembling inputs for the model. Second, existing systems generally do not maintain a unified processing pipeline in which encrypted biological data, external research information, and model responses are consistently linked and managed end-to-end under a common access control and backup/restore framework. This disconnect increases memory usage, complicates cache management, and raises the risk of data inconsistency between application logic and storage layers. Third, many systems do not incorporate emotion information from a user device into the computational pipeline in a structured way. Emotion recognition, if present at all, is often implemented as an independent front-end feature, without feeding back the emotion state into the prompt generation logic and response adaptation logic executed by the server processor. Consequently, the server cannot algorithmically adjust prompt sentences or generated outputs in real time based on emotional context, which leads to redundant model calls, inefficient recomputation, and suboptimal bandwidth usage. Fourth, product recommendation and electronic settlement functions, when combined with medical or biological information, are typically implemented as separate subsystems. There is no coordinated management of how recommendation candidate information is generated using the same generative AI model, how this information is stored and encrypted together with the underlying biological context, and how security alerts are computed and delivered based on user emotion and system state. This separation forces multiple, loosely coupled calls to different services, increases network overhead, and complicates state management across components.

Accordingly, there is a need for a computer-implemented system that improves the way a server processor ingests biological information, encrypts and stores that information, acquires and formats related research information, automatically generates prompt sentences for a generative AI model, processes model responses into structured explanation information, and adaptively modifies both prompts and outputs based on emotion information, while also integrating recommendation and electronic settlement logic under a unified, access-controlled, backup-capable data management scheme. Such a system should improve the functioning of the computer itself by reducing redundant processing, streamlining data paths between storage, AI services, and user devices, and enabling more efficient and context-aware use of generative AI resources.

The specific processing by the specific processing unit 290 of the data processing device 12 in Application Example 2 is realized by the following means.

The present invention provides a server comprising a processor configured to receive biological information from a user through an input interface of a terminal device, encrypt the biological information and store the encrypted biological information in a storage, decrypt the encrypted biological information from the storage to obtain the biological information, acquire research information corresponding to the biological information from an external information source and perform a formatting process on the research information to generate structured research data, generate a prompt sentence to be input to a generative AI model on the basis of the biological information and the structured research data, transmit the prompt sentence to the generative AI model, analyze response information obtained from the generative AI model to generate explanation information including treatment method information, risk information, and lifestyle proposal information, transmit the explanation information to the terminal device as display information, receive emotion information representing an emotional state of the user acquired by the terminal device, adjust contents of the prompt sentence and an expression style of the explanation information on the basis of the emotion information, select a health-related product or a health-related service on the basis of the explanation information, present a selection result to the terminal device, generate transaction information for an electronic settlement process, encrypt at least a portion of the biological information, the explanation information, and the transaction information, control access to encrypted information on the basis of access authority, and perform backup and restoration of the encrypted information. This enables an integrated and technically improved processing pipeline in which sensitive biological data, emotion data, model prompts, model responses, recommendation information, and transaction information are consistently managed by the server processor, thereby reducing redundant data transfers and computations, improving security and reliability of storage and access control, optimizing the generation and reuse of prompt sentences for the generative AI model, and enhancing the overall efficiency and responsiveness of the computer system when providing adaptive, AI-generated explanation and recommendation information to the user.

The term “biological information” refers to information indicating a biological characteristic of an individual, including but not limited to genetic sequence data, genetic variant data, biomarker data, and metadata associated with such data.

The term “input interface” refers to a hardware or software component configured to receive data from a user, such as a graphical user interface, a touch screen, a keyboard, a pointing device, a camera, a microphone, or a data import module.

The term “terminal device” refers to an information processing apparatus operated by a user, such as a portable information processing apparatus, a desktop information processing apparatus, or a network-connected display apparatus.

The term “storage” refers to a data retention resource, including at least one non-transitory computer-readable recording medium, such as a magnetic recording medium, a semiconductor memory, or a remote storage service accessible over a communication network.

The term “external information source” refers to a data providing resource located outside the server, such as an external database, an external server, or a network service that supplies research information through a communication interface.

The term “research information” refers to information related to biological information, including scientific findings, clinical guideline information, therapeutic efficacy data, statistical risk information, and other study-related data.

The term “formatting process” refers to processing that converts unstructured or semi-structured data into structured data, including operations such as parsing, normalizing, filtering, aggregating, and organizing data into a predefined schema.

The term “generative AI model” refers to a data processing model implemented by one or more processors and configured to generate output information, such as natural language text or structured data, based on input information including a prompt sentence.

The term “prompt sentence” refers to a sequence of symbols, including natural language text, that instructs a generative AI model regarding a requested output, a desired style, a desired level of detail, or a context for information generation.

The term “response information” refers to information output by a generative AI model in response to a prompt sentence, including natural language explanations, lists, tables, or other generated content.

The term “explanation information” refers to information generated on the basis of response information and underlying data, and including at least one of treatment method information, risk information, and lifestyle proposal information formatted for presentation to a user.

The term “treatment method information” refers to information indicating a medical or health-related intervention method, including preventive actions, diagnostic actions, therapeutic actions, or monitoring actions associated with a biological condition.

The term “risk information” refers to information indicating a probability, likelihood, or severity of a health-related event or condition associated with biological information.

The term “lifestyle proposal information” refers to information indicating recommended behaviors, habits, or environmental adjustments intended to maintain or improve health, including recommendations relating to diet, exercise, rest, and stress management.

The term “display information” refers to information formatted for visual or auditory presentation to a user via a terminal device, including text, images, graphics, icons, audio, or combinations thereof.

The term “emotion information” refers to information indicating an emotional state of a user, such as anxiety, stress, calmness, or happiness, and may include a label, a score, or other representation of the emotional state.

The term “emotional state” refers to a psychological condition of a user at a given time, such as an anxious state, a high-stress state, a relaxed state, or another affective condition.

The term “expression style” refers to a manner in which information is presented, including tone, level of technical detail, choice of terminology, structure, and emphasis of content.

The term “health-related product” refers to a tangible or intangible offering related to health support, including consumable products, monitoring devices, or software services intended to affect or monitor health.

The term “health-related service” refers to a service related to health, such as consultation, counseling, training, or subscription-based wellness support.

The term “selection result” refers to information indicating at least one selected health-related product or health-related service, and may include an identifier, a description, and a recommended reason.

The term “transaction information” refers to information used for execution of an electronic settlement process, including product identifiers, service identifiers, price data, user identifiers, and payment-related parameters.

The term “electronic settlement process” refers to a process for executing payment by using electronic communication, including transmission of payment information to a payment processing system and receipt of a settlement result.

The term “encrypted information” refers to information that has been transformed using an encryption algorithm and an encryption key so that the information is not directly interpretable without corresponding decryption processing.

The term “access authority” refers to permission information indicating whether a subject such as a user or a process is allowed to access specific information or execute specific operations.

The term “backup” refers to processing in which a copy of data is generated and stored in a storage location different from an original storage location for protection against loss or corruption.

The term “restoration” refers to processing in which backup data is used to reconstruct data in a state usable by a system after loss, corruption, or failure.

The term “image information” refers to information acquired by an image capturing apparatus, such as a video frame or a still image, and including pixel values or feature values derived therefrom.

The term “audio information” refers to information acquired by a sound capturing apparatus, such as a voice signal or an environmental sound signal, and including waveform data or feature values derived therefrom.

The term “emotion recognition processing” refers to processing that analyzes at least one of image information and audio information to determine an emotional state of a user, using pattern recognition, statistical analysis, or machine learning.

The term “high-load risk information” refers to risk information that may impose a high psychological or cognitive burden on a user, such as information describing severe outcomes or high probabilities of adverse events.

The term “stepwise presentation” refers to a presentation mode in which information is provided progressively in stages, such that a subset of information is first presented and additional details are revealed according to a condition.

The term “product information” refers to information describing a commercial offering, including at least an identifier, a name, a description, and optionally a price or availability status.

The term “service information” refers to information describing a commercial service offering, including at least an identifier, a name, a description, and optionally a price or subscription condition.

The term “recommendation candidate information” refers to information indicating one or more candidate products or services proposed for recommendation based on underlying data and processing, including candidate identifiers and associated rationales.

The term “security warning information” refers to information generated to alert a user to a security-related condition, such as potential privacy risks, unsafe communication conditions, or recommended protective actions.

Various embodiments for carrying out the invention will now be described. In the following description, a “server” denotes an information processing apparatus including at least one processor, a memory, and a network interface. A “terminal” denotes a user-operated information processing apparatus such as a portable communication apparatus, a desktop apparatus, or another network-connected apparatus. A “user” denotes a human operator of the terminal.

### 1. Overall System Configuration

Server executes program modules stored in a non-transitory computer-readable medium. The modules include at least: a biological information management module, an encryption and access control module, a research information acquisition and formatting module, a prompt generation module, a generative AI interface module, a response analysis module, an emotion information processing module, a recommendation and transaction module, and a backup and restoration module.

Server communicates with terminal through a communication network using a secure protocol such as HTTPS over a transport layer security protocol. Terminal runs an application implemented, for example, using a cross-platform application framework and a web rendering framework. The application provides user interfaces for biological information input, consent input, emotion input, result display, and purchase operations.

Terminal includes at least a display, a touch or pointing input device, a camera, a microphone, and a local storage. Terminal executes an emotion recognition module that acquires image information from the camera and audio information from the microphone and calculates emotion information for the user.

User operates terminal to input biological information, consent information, and operation instructions, and to view explanation information and recommendation information.

### 2. Biological Information Input and Encryption

Server stores biological information inside a structured storage such as a relational database system or a key-value store running on a storage subsystem. Server does not store the biological information in plaintext; instead, the biological information is stored as encrypted information using a symmetric-key encryption algorithm such as an advanced encryption standard algorithm with a key length of 256 bits.

Server includes an encryption and decryption engine implemented as a software library, for example, a cryptographic library. The engine generates a random initialization vector for each encryption operation, derives or retrieves an encryption key from a secure key store or hardware security module, and applies a block cipher mode such as a counter or Galois/Counter mode. The engine generates ciphertext and an authentication tag. Server stores at least a user identifier, the ciphertext, the initialization vector, the authentication tag, and metadata such as timestamps.

Server configures the database schema so that the biological information is always accessed through an encryption layer. This architecture reduces the attack surface compared to systems that store plaintext biological information in multiple application-layer caches. Because the encryption engine is centralized and integrated with the database access layer, server eliminates redundant encryption and decryption inside application logic and improves processing speed and consistency of security enforcement.

### 3. Research Information Acquisition and Formatting

Server acquires research information corresponding to the biological information from an external information source such as an external database or an external server. Server uses an HTTP client library to call an application programming interface exposed by the external information source. The external information source returns research information, for example, as structured data (e.g., JavaScript object notation, comma-separated values, or an extensible markup language format) that includes identifiers for genetic variants, associated diseases, treatment efficacy statistics, and guideline references.

Server executes a research information acquisition and formatting module that converts the received research information into a normalized internal representation. Server uses a data analysis library such as a tabular data processing library to:
parse incoming data into tables,
normalize identifiers (e.g., gene symbols, variant descriptors) to a reference set,
remove irrelevant or duplicate records,
aggregate evidence by variant or by disease,
assign internal evidence levels or weights.

Server stores structured research data in a research evidence table that includes fields such as gene identifier, variant pattern, disease category, treatment identifier, effect size, evidence level, and update timestamp. By performing this formatting process once at the server side and reusing the structured research data for multiple users, server reduces repeated parsing and normalization operations, thereby improving throughput and reducing computation time compared to systems that process research information ad hoc for each request.

### 4. Generative AI Model Interface and Internal Architecture

Server communicates with a generative AI model through a generative AI interface module.

The generative AI model is implemented as a neural network model for sequence-to-sequence natural language generation or structured data generation, and is executed on one or more computing resources such as a remote AI service or a local accelerator. In one embodiment, the generative AI model is a transformer-type model comprising a plurality of encoder-decoder layers. Each layer includes multi-head self-attention units, feed-forward networks, normalization units, and residual connections.

The generative AI model is trained in advance using supervised learning on large-scale corpora including medical literature, guidelines, and explanatory texts. The training process uses a loss function such as cross-entropy between predicted token sequences and target token sequences. The model uses gradient-based optimization such as stochastic gradient descent with an adaptive learning rate method. During training, the model updates weights of attention matrices and feed-forward networks by backpropagation of errors computed over batches of input-output pairs. The model may employ regularization methods such as dropout and weight decay and data augmentation such as paraphrasing or masking of sentences to improve generalization.

In the deployed phase, server does not retrain the generative AI model for each user; rather, server fine-tunes or conditions the model using prompt sentences and, optionally, small adapter layers. Server prepares input token sequences by encoding prompt sentences and structured context using a tokenizer. The generative AI model processes these token sequences and generates output token sequences according to a decoding algorithm such as beam search or nucleus sampling.

Because the model internally represents the relationship between sequence tokens using attention matrices, it can integrate multiple types of context (biological information, research information, emotion information, and recommendation constraints) in a more flexible manner than traditional rule-based or template-based systems. This architecture allows the system to reduce handcrafted rule logic and achieve higher coverage and adaptability, while the server-specific prompt generation and response parsing logic impose a deterministic structure around the model's behavior to maintain reliability.

### 5. Prompt Sentence Generation

Server generates a prompt sentence that controls the generative AI model. The prompt sentence is not a fixed template; instead, the prompt generation module constructs the prompt by programmatically combining multiple pieces of information:
biological information fields such as gene identifiers and variant descriptions,
selected fields from the structured research data such as effect sizes and guideline notes,
user preferences such as desired verbosity and language complexity,
emotion information representing the user's current emotional state,
recommendation context such as whether product suggestions are requested.

Server uses a natural language processing library to extract key terms from research summaries and to rank them by importance using metrics such as term frequency-inverse document frequency or learned attention weights from a classifier model. Server then organizes the key terms into a structured outline (for example, “summary of variant”, “risk”, “treatment”, “lifestyle”). The prompt generation module maps this outline to a hierarchical text structure.

An example of a prompt sentence generated by the server is:

“Based on the user's genetic variant BRCA1 c.5266dupC and the latest clinical research data indicating increased risk of breast and ovarian cancer, generate a clear and concise explanation for a non-expert user that includes: (1) a summary of the variant and its significance, (2) the latest treatment options and their effectiveness, (3) the main health risks, and (4) practical lifestyle recommendations. Use headings and bullet points, avoid technical jargon, and explicitly mention that the explanation does not replace consultation with a medical professional.”

When the server receives emotion information indicating that the user is anxious, the server modifies the prompt sentence as follows:

“The user is currently feeling anxious about the genetic results. Using a calm and reassuring tone, and based on the user's genetic variant BRCA1 c.5266dupC and the latest clinical research data, generate an explanation for a non-expert user that includes: (1) a brief and reassuring summary of the variant, (2) a balanced description of risks without sensational expressions, (3) practical, step-by-step lifestyle recommendations to reduce anxiety and manage health, and (4) guidance on when to seek professional support.” Server thereby encodes emotion-driven constraints directly into the prompt sentence, enabling the generative AI model to produce outputs that are customized for the user's emotional state. The dynamic prompt construction avoids static, one-size-fits-all templates and reduces the need for multiple post-processing passes on the generated text, which improves response time and reduces computational overhead.

### 6. Response Analysis and Explanation Information Generation

Server receives response information from the generative AI model as a token sequence. The response analysis module decodes the token sequence into text and optionally into a structured representation. To achieve robust parsing, server instructs the generative AI model in the prompt sentence to output content in a semi-structured format, for example, with labeled sections such as “Summary:”, “Risks:”, “Treatments:”, and “Lifestyle:”.

Server identifies section boundaries using simple pattern matching or a lightweight parser, and maps each section to internal fields in an explanation information object. For example, server maps “Summary:” to a summary field, “Risks:” to a risk information field, and so on.

Server may further run a consistency check using a secondary classifier model or rule set to ensure that prohibited phrases or formats are not present, and to check whether all required sections are present. If inconsistencies are detected, server can adjust the prompt sentence and re-query the generative AI model, or locally correct minor issues.

The explanation information generated in this way remains linked to the underlying biological information and research data through identifiers stored in the database. This link allows the server to regenerate explanations when research information is updated, without reprocessing the biological information from scratch. Such linkage contributes to efficiency and consistency, as server can selectively update only sections affected by new evidence, rather than rebuilding entire documents.

### 7. Emotion Information Processing and Adaptation

Terminal acquires emotion information by performing emotion recognition processing locally. Terminal uses the camera to capture face images and uses the microphone to capture voice. A convolutional neural network or a hybrid convolutional-recurrent network runs on the terminal to extract facial features such as action unit intensities, eye openness, and mouth curvature. The network consists, for example, of multiple convolution layers with rectified linear units, pooling layers, and fully connected layers, followed by a softmax output layer that yields emotion probabilities.

For audio, terminal extracts features such as Mel-frequency cepstral coefficients and pitch-related features. A recurrent neural network or transformer-based encoder may analyze the sequence of audio features to classify emotional valence and arousal. Terminal may fuse the visual and audio emotion probabilities using weighted averaging or a small multi-layer perceptron to obtain a single emotion label such as “anxious” with a confidence score.

Terminal transmits the resulting emotion information to server as a compact data structure containing an emotion label, a numeric confidence, and a timestamp. Because only derived emotion information is transmitted, and not raw biometric data, network bandwidth is conserved, and privacy exposure is reduced.

Server receives the emotion information and stores it as user emotion state. Server uses this state in two ways. First, server adjusts the prompt sentence as described above. Second, server can adjust the display-level parameters of explanation information, such as hiding certain high-load risk details in initial views, or adding additional supportive context in the lifestyle section. By centralizing emotion-based adaptation logic in the server, the system achieves consistent and technically controlled behavior regardless of variations among terminal implementations.

This emotion-driven adaptation is not a mere business rule; rather, it causes a specific reconfiguration of the AI-processing pipeline, including altered prompt generation, selective field suppression, and modified section ordering, which in turn reduces cognitive overload, reduces the need for repeated user queries, and can reduce the number of re-queries to the generative AI model, thereby improving computational efficiency.

### 8. Recommendation and Transaction Processing

Server uses explanation information and emotion information to generate recommendation candidate information for health-related products and services. Server executes a recommendation module that may include at least two components: a rule-based filter and a learned ranking model.

The rule-based filter uses structured fields such as affected organ system, risk level, and lifestyle constraints to eliminate products that are medically irrelevant or contraindicated. For example, if the explanation information indicates increased risk due to a specific metabolic impairment, the rule-based filter can exclude products that rely on that metabolism pathway. The learned ranking model is implemented as a neural ranking network that receives as input a vector representation of the user's biological profile, a vector representation of the explanation information (derived from a text encoder), a vector representation of emotion information, and a vector representation of each candidate product's attributes. The ranking network is trained to optimize a ranking loss function such as a pairwise hinge loss or a listwise loss, using historical data relating product selections to user profiles.

Server uses the ranking results to select a subset of candidate products or services and then prepares a prompt sentence for the generative AI model to generate human-readable rationales. An example prompt sentence used in this context is:

“Based on the user's genetic profile indicating increased sensitivity to stress and reduced tolerance to certain medications, and considering that the user is currently experiencing high stress, generate short, non-technical explanations for why each of the following categories of products or services may be appropriate: (1) relaxation aids, (2) mindfulness or counseling services, and (3) lifestyle coaching programs. For each category, describe in two or three sentences how it relates to the user's profile and how it may help.”

Server passes the prompt sentence together with brief product category descriptors to the generative AI model and receives generated rationales. Server then combines the rationales with product identifiers, prices, and other metadata from the product catalog and sends them to terminal.

Terminal displays the recommendations together with rationales. If user selects a product or service, terminal collects payment-related parameters (e.g., tokenized payment credentials) and transmits transaction information to server. Server interfaces with a payment processing system through an application programming interface and receives settlement results. Server then records transaction information as encrypted information in storage.

By tightly integrating the recommendation logic, AI-generated rationales, and transaction recording with the encrypted storage and access control framework, server reduces the number of separate services and data copies required. This consolidation improves latency and reduces potential inconsistencies between recommendation content and recorded transactions.

### 9. Backup, Restoration, and Access Control

Server performs backup and restoration of encrypted information such as encrypted biological information, encrypted explanation information, and encrypted transaction information. Server periodically generates backup files that contain database dumps or snapshots of storage volumes. The backups are themselves encrypted using a key hierarchy, and stored in a backup storage separate from the primary storage. When a failure or data corruption is detected, server reconstructs data by loading the backup into replacement storage, verifying integrity using checksums, and re-establishing keys and access control settings.

Server enforces access control by associating access authority information with each data record. Server maintains user roles and permissions and intercepts all read and write operations at the application layer or database layer. Server checks whether the requesting subject (for example, a user session or an internal module) has authority to access specific categories of encrypted information, and denies operations that do not satisfy the criteria. This mechanism, together with encryption, reduces the risk of unauthorized access and supports compliance with privacy regulations.

### 10. Technical Effects and Improvement of Computer Technology

The described system improves computer technology in several ways:
Server reduces redundant decryption and encryption operations by centralizing these operations at the storage boundary and by storing biological information, explanation information, and transaction information in encrypted form with structured metadata. This reduces memory footprint and improves throughput for large-scale deployments.
Server reduces computation and communication overhead associated with generative AI processing by dynamically generating prompt sentences that integrate all relevant context (biological information, research information, emotion information, and recommendation context), thereby avoiding multiple separate AI calls and reducing the need for extensive application-layer post-processing.
Server improves response time and system stability by pre-formatting research information into a structured evidence table once, and then reusing it across multiple requests. This design avoids repeating expensive parsing and normalization for each user request.
The emotion-driven adaptation pipeline reduces unnecessary network traffic and model invocations by controlling when and how additional detail is presented to the user, thereby decreasing the likelihood of repeated queries and re-generation of explanations due to misunderstanding or emotional overload.
The integration of AI-based text generation with deterministic parsing and rule-based checks yields more reliable outputs than purely template-based approaches or purely free-form generation. This hybrid architecture contributes to lower error rates and reduces manual intervention.
The recommendation module's combination of rule-based safety filters with a learned ranking model, followed by AI-generated natural language rationales, allows the server to perform recommendation computations and explanation generation in a coordinated manner that is not feasible in manual or naive automation workflows. The resulting pipeline leverages specific neural network architectures and loss functions to optimize ranking performance, thereby improving recommendation precision and relevance.

These technical effects arise from specific data structures, processing modules, and AI model interactions defined by the server and terminal architecture, rather than from mere automation of a human mental process. The server controls memory usage patterns, encryption boundaries, network communication sequences, and neural model invocation patterns in a way that measurably improves performance, accuracy, and security of the computer system itself.

### 11. Variations and Alternative Embodiments

Server may run multiple generative AI models, for example, a larger model for initial detailed generation and a smaller distilled model for quick updates or lower-latency responses. Server may select the model based on resource conditions or user settings. Server may also use a local generative model for certain tasks (such as summarization or paraphrasing) and a remote model for others (such as complex reasoning).

Server may employ different neural network architectures for the generative AI model, including encoder-only models for classification tasks (e.g., content safety checks) and decoder-only models for generation tasks. Server may integrate adapter layers or low-rank adaptation parameters that are fine-tuned using task-specific data such as anonymized user feedback, thereby customizing the behavior without retraining the full model.

Terminal may implement lightweight models for on-device emotion recognition using quantized weights or reduced-resolution inputs to minimize computation and power consumption. When higher accuracy is required, terminal may offload certain emotion recognition tasks to server, transmitting pre-processed features instead of raw images or audio.

The described modules can be arranged in different configurations. For example, the research information acquisition and formatting module may be deployed on a separate auxiliary server and communicate with the main server through an internal network. In another embodiment, certain parts of the recommendation logic may run on terminal if product catalogs are cached locally, while the central encryption and generative AI interface remain on server.

In all these embodiments, server, terminal, and user cooperate according to the same fundamental concepts: biological information and derived information are encrypted and managed under access control; research information is normalized and reused; prompt sentences to a generative AI model are dynamically constructed from multiple contexts; model responses are analyzed into structured explanation information; emotion information is used to adapt both prompts and outputs; and recommendation and transaction information is generated and stored within the same secure computational framework.

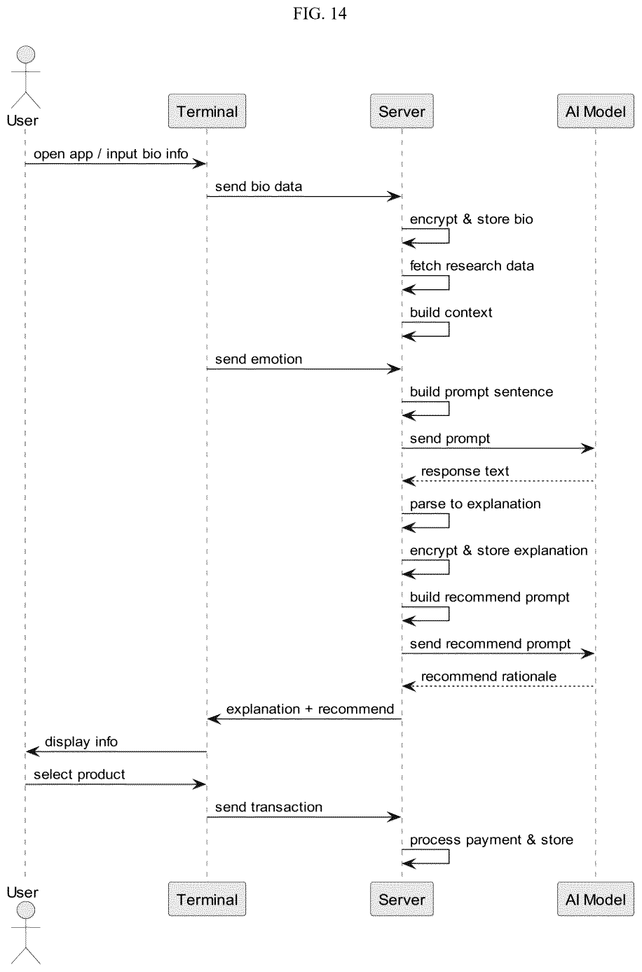

The following describes the processing flow using FIG. 14.

### Step 1:

User operates the terminal to input biological information.

User launches an application on the terminal and selects a biological information input screen. User types genetic variant identifiers and related clinical data into form fields, or instructs the terminal to scan a code on a laboratory report or to import a data file. The input of this step is raw biological information provided by the user (for example, gene names, variant descriptions, and metadata). The output of this step is user-entered biological information displayed on the terminal and held in temporary memory inside the terminal in a structured or semi-structured format.

### Step 2:

Terminal structures and validates the biological information and sends it to the server.

Terminal parses text fields, scanned codes, or imported files to extract standardized fields such as user identifier, gene identifier, variant string, and sample identifier. Terminal checks formats (for example, pattern of a variant string) and may prompt the user to correct obvious errors. The input of this step is the raw biological information entered or captured in Step 1. Terminal performs data processing by mapping free-form text to internal fields, normalizing character encodings, and assembling a structured data object. The output of this step is a structured biological information object, which the terminal transmits to the server over a secure communication channel.

### Step 3:

Server receives the structured biological information and encrypts it for storage.

Server accepts a network request from the terminal and reads the structured biological information from the request body. The input of this step is the structured biological information received from the terminal. Server executes an encryption routine that generates a random initialization vector, selects an encryption key, and applies a symmetric encryption algorithm to convert the biological information into ciphertext and an authentication tag. This data processing transforms readable biological information into encrypted information that cannot be directly interpreted without decryption. The output of this step is an encrypted biological information record containing ciphertext, initialization vector, authentication tag, and associated metadata, which the server stores in a database or storage subsystem.

### Step 4:

Server acquires and formats research information corresponding to the biological information.

Server analyzes the structured biological information (either before encryption in memory or after decryption when needed) to identify relevant genes, variant patterns, and disease categories. The input of this step is the biological information associated with the user's record. Server sends requests to one or more external information sources, such as remote databases, and receives research data describing variant-disease associations, treatment outcomes, and guideline recommendations. Server then processes this incoming data by parsing response structures, normalizing identifiers, removing duplicates, and aggregating statistics into an internal research table. The data processing here transforms heterogeneous, unstructured or semi-structured research data into consistent structured research data linked to the user's biological information. The output of this step is a set of structured research entries stored in the server's research evidence storage, and a subset of those entries selected for the user's variants.

### Step 5:

Server prepares a combined context object for prompt generation.

Server retrieves the user's biological information (by decrypting the stored ciphertext if necessary) and the subset of structured research data associated with that biological information. The input of this step is encrypted biological information and research evidence records produced in previous steps. Server decrypts the biological information in memory, retrieves matching research evidence, and then constructs a context object that includes variant identifiers, risk metrics, treatment names, and summarized research notes. The data processing combines multiple tables and fields into a single internal data structure designed for natural language prompt construction. The output of this step is a context object containing all information that the prompt generation module will use.

### Step 6:

Terminal acquires emotion information and sends it to the server.

Terminal runs an emotion recognition module using the camera and microphone. Terminal captures image information of the user's face and audio information of the user's voice while the user interacts with the application. The input of this step is raw multimedia data (video frames and audio samples) from the terminal's sensors. Terminal applies trained neural network models to compute features such as facial expression vectors and prosodic patterns, and then classifies these features into one of several emotion categories with associated confidence values. This data processing converts raw sensor signals into a compact emotion label (for example, “anxious” or “calm”) and a numeric confidence. The output of this step is emotion information, which the terminal sends to the server as a small structured message.

### Step 7:

Server generates a prompt sentence for a generative AI model based on biological, research, and emotion information.

Server receives the emotion information from the terminal and links it to the user's current context. The input of this step is the context object from Step 5 and the emotion information from Step 6. Server performs natural language pre-processing on research summaries to extract key terms and organizes them by topic (summary, risk, treatment, lifestyle). Server then synthesizes a prompt sentence by combining these elements and adding instruction phrases that specify style, structure, and emotional tone. This data processing transforms structured numerical and textual data into a natural language instruction string that is suitable for controlling a generative AI model. The output of this step is at least one prompt sentence that reflects the user's biological profile, research findings, and emotional state.

### Step 8:

Server transmits the prompt sentence to the generative AI model and obtains response information.

Server sends the prompt sentence as an input sequence to a generative AI model through an application programming interface or a local model invocation. The input of this step is the prompt sentence generated in Step 7, optionally accompanied by auxiliary context tokens. Inside the generative AI model, a neural network processes the tokenized prompt using attention-based layers and feed-forward computations to produce predicted output tokens. From the server's perspective, the data processing is the invocation of the model and the reception of the resulting token sequence. The output of this step is response information, typically in the form of generated text that describes explanation content corresponding to the instructions in the prompt sentence.

### Step 9:

Server parses and structures the response information into explanation information.

Server decodes the token sequence received from the generative AI model into text. The input of this step is raw response text produced by the model in Step 8. Server analyzes the text using pattern recognition and section markers such as headings or tags to identify segments corresponding to summary, risk information, treatment method information, and lifestyle proposal information. Server may also check for missing sections or disallowed expressions. This data processing transforms a free-form text into a multi-field explanation information object where each field is aligned with a specific category relevant to the user's biological information. The output of this step is structured explanation information that can be stored, displayed, and further processed.

### Step 10:

Server encrypts and stores the explanation information.

Server treats explanation information as sensitive data connected to the biological profile. The input of this step is the structured explanation information from Step 9. Server applies the encryption routine used for biological information, generating a new initialization vector and computing ciphertext and an authentication tag for the explanation information. The data processing converts readable explanation content into encrypted information suitable for secure storage. The output of this step is an encrypted explanation record stored in the server's database, linked to the corresponding encrypted biological record.

### Step 11:

Server generates recommendation candidate information and associated prompt sentences for rationale generation.

Server uses explanation information fields (for example, risk categories and lifestyle constraints) together with product and service catalog data to identify potential health-related products and services. The input of this step is explanation information and catalog entries.

Server applies rule-based filtering and learned scoring algorithms to compute a relevance score for each candidate and to select a subset. Server then constructs a new prompt sentence instructing the generative AI model to generate simple rationales for each selected product or service category. This data processing converts numeric relevance scores and catalog metadata into both a list of recommendation candidates and a textual instruction for rationale generation. The output of this step is recommendation candidate information and at least one prompt sentence directed to rationale generation.

### Step 12:

Server obtains rationales from the generative AI model and assembles final recommendation information.

Server sends the recommendation-oriented prompt sentence to the generative AI model and receives generated rationales. The input of this step is the recommendation prompt and, optionally, brief product category descriptors. Server then combines the model's response text with the selected product or service identifiers and prices. This data processing merges human-readable explanatory content with structured catalog data into a unified recommendation information structure. The output of this step is recommendation information, including lists of health-related products or services and associated user-friendly explanations.

### Step 13:

Server transmits explanation information and recommendation information to the terminal.

Server prepares response messages that contain decrypted explanation text and recommendation information suitable for display. The input of this step is the structured explanation information and recommendation information generated and stored in previous steps. Server may convert structured fields into display markup or formatted text. This data processing transforms internal field representations into presentation-ready content. The output of this step is display information transmitted to the terminal as network responses.

### Step 14:

Terminal displays explanation information and recommendation information to the user.

Terminal receives display information from the server and renders it in the application interface. The input of this step is the display information payload received over the network.

Terminal arranges headings, bullet lists, charts, and product tiles on the screen, and may convert sections into speech for accessibility. This data processing turns structured display instructions into graphical or auditory output on terminal hardware. The output of this step is the visible and/or audible presentation of explanation information and recommendation information to the user.

### Step 15:

User reviews the information and optionally initiates a transaction.

User reads or listens to the explanation information and evaluates recommendation information. The input of this step is the displayed content on the terminal. User decides whether to select one of the proposed products or services and, if desired, interacts with buttons or controls on the screen to initiate purchase. The output of this step is user action data (for example, a selected product identifier and confirmation) captured by the terminal.

### Step 16:

Terminal collects transaction parameters and sends transaction information to the server.

Terminal prompts the user for confirmation and, where necessary, retrieves stored payment credentials or collects new credentials. The input of this step is the user's selection from Step 15 and any stored or entered payment parameters. Terminal assembles transaction information including user identifier, product or service identifier, quantity, and payment token. This data processing converts user interface actions and payment details into a structured transaction object. The output of this step is transaction information transmitted securely to the server.

### Step 17:

Server performs electronic settlement and encrypts the resulting transaction record.

Server receives transaction information from the terminal and forwards payment-related fields to an external payment processing system. The input of this step is the transaction information created in Step 16. Server waits for a response indicating approval or failure and then constructs a complete transaction record including status and timestamps. Server applies its encryption routine to secure this transaction record before storage. This data processing executes a payment protocol, interprets responses, and transforms transaction details into encrypted information. The output of this step is an encrypted transaction record stored in the server's storage and a settlement result that the server can report back to the terminal.

### Step 18:

Server and terminal update emotion information and adapt further interactions.

Terminal continues to monitor the user's emotional state as the user views explanations and interacts with recommendations. The input of this step is new sensor data and current explanation content. Terminal recalculates emotion labels and sends updated emotion information to the server. Server uses the incoming emotion information together with logs of viewed sections to decide whether to regenerate parts of the explanation or adjust future prompt sentences. The data processing at the server side converts updated emotion information into changes in model invocation parameters and display-level filters. The output of this step is modified prompt sentences and, when triggered, updated explanation or recommendation information that are transmitted to the terminal for a more appropriate user experience.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

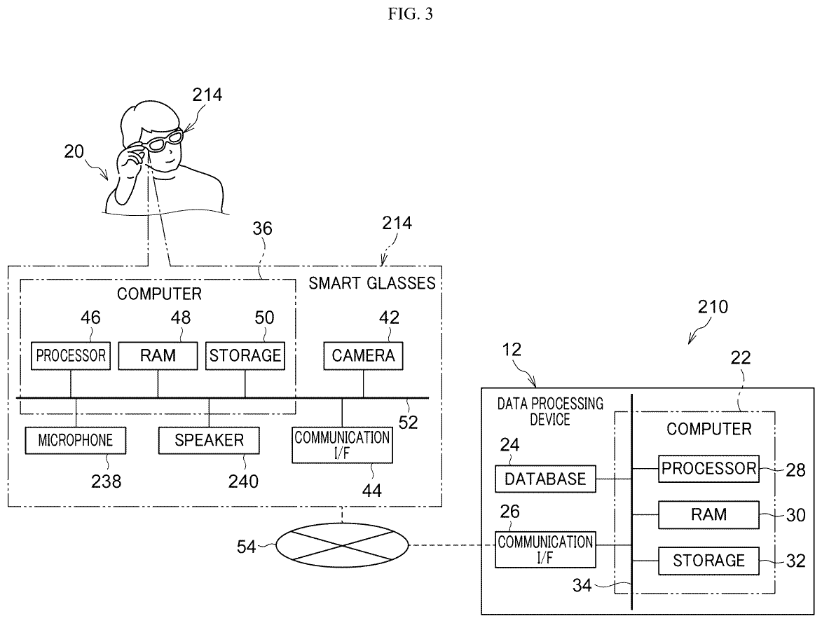

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

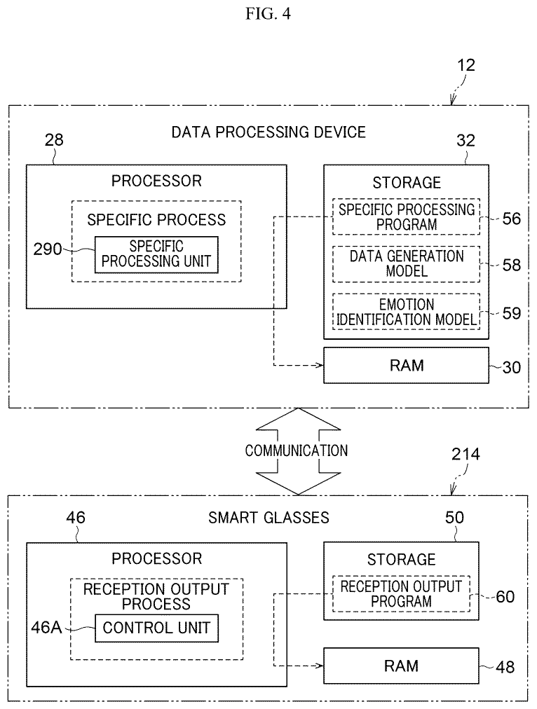

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

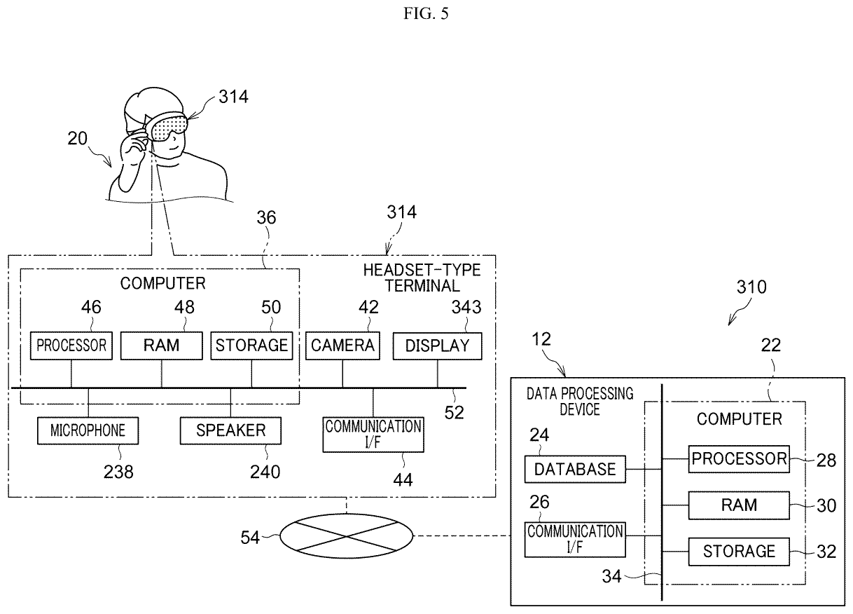

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

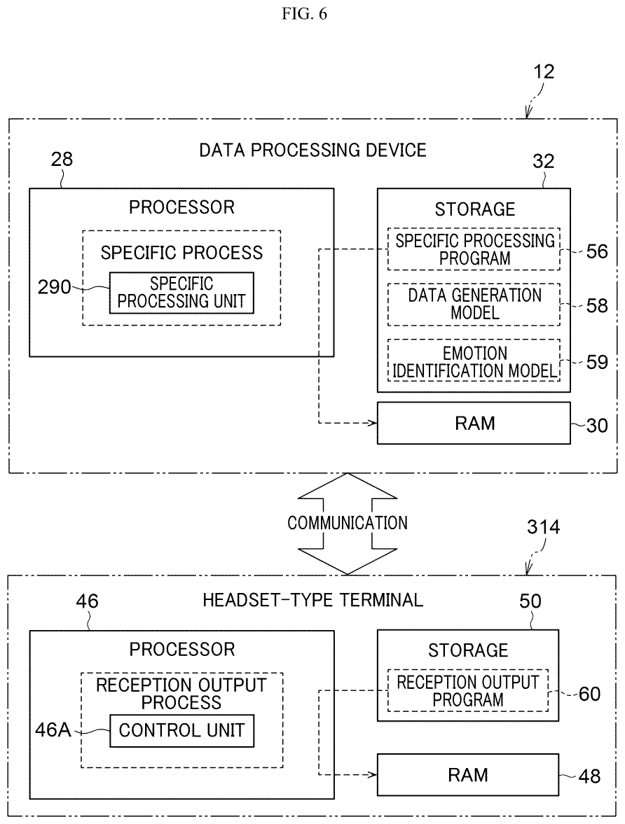

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

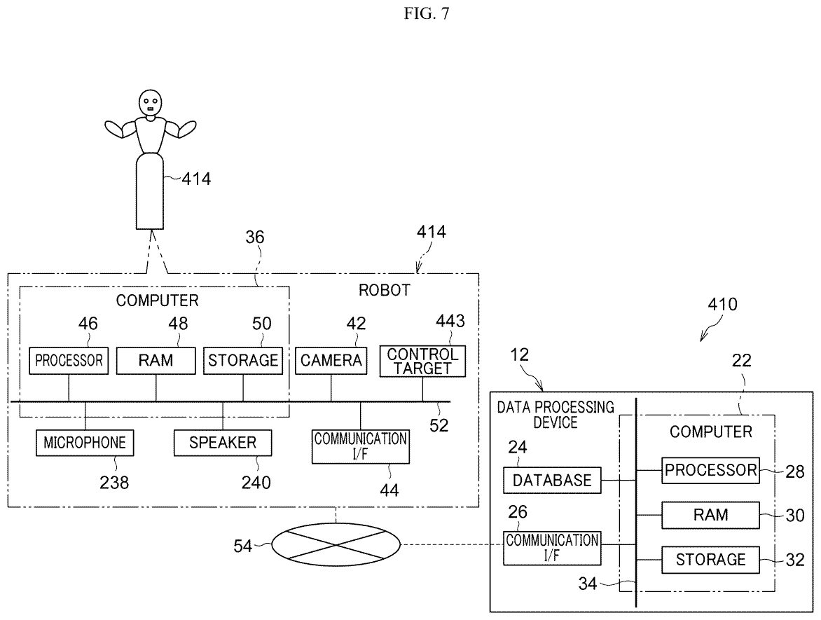

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

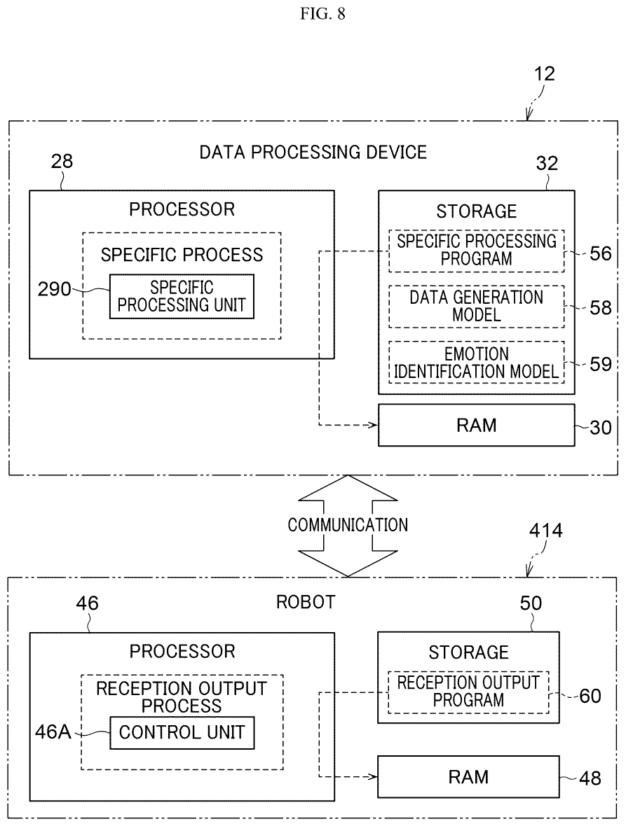

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

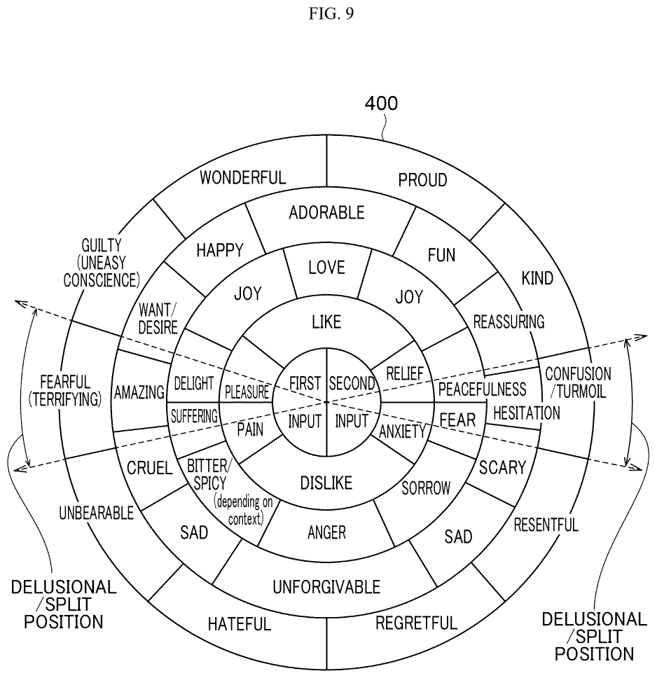

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

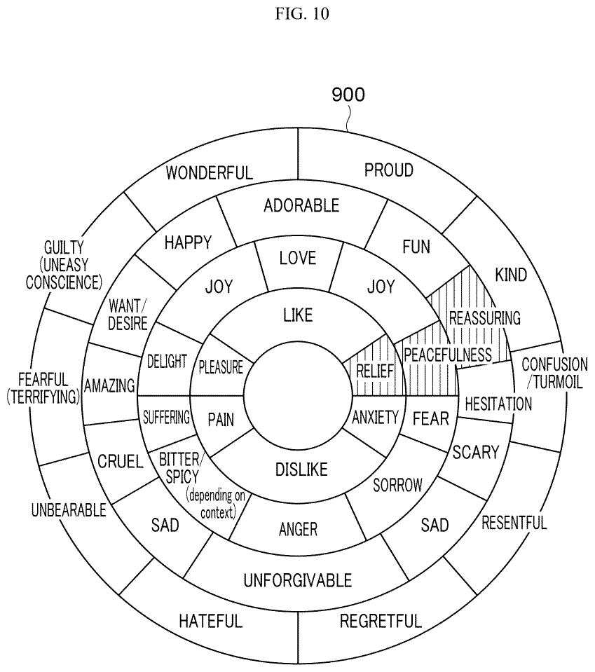

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### EXAMPLE 1

### (Supplementary 1)

A system comprising a processor,
wherein the processor is configured to
receive structured data including biological-related information from a terminal that acquires the biological-related information from a user,
normalize and validate the biological-related information based on the structured data, and obtain and append attribute information related to the biological-related information from a storage device,
automatically generate a prompt sentence to be input to a generative information processing model, in accordance with template information selected from a plurality of template information, based on the normalized biological-related information and the attribute information,
input the automatically generated prompt sentence to the generative information processing model, cause the generative information processing model to perform inference processing and summarization processing of medical-related information based on the biological-related information, and obtain generated information including individualized medical-related information,
generate individualized information including risk assessment information, medical procedure candidate information, and lifestyle guidance candidate information, based on the generated information and the attribute information,
transmit the individualized information as visualization-structured data to the terminal, and cause the terminal to present the individualized information as a dashboard-type display and an interactive operation screen, and
store and manage the biological-related information, the prompt sentence, the generated information, and the individualized information in the storage device together with encryption processing and usage-authorization control processing.

### (Supplementary 2)

The system according to Supplementary 1,
wherein the processor is configured to generate the prompt sentence based on template information that is dynamically selected according to a type of the biological-related information, variation classification information, and the attribute information, and, when additional input information including a follow-up question from the user is received, to repeatedly execute control for generating a supplemental prompt sentence to which the additional input information is appended, inputting the supplemental prompt sentence to the generative information processing model, and causing the generative information processing model to generate additional explanation information.

### (Supplementary 3)

The system according to Supplementary 1,
wherein the processor is configured to generate analysis data in which personal identification information is removed or replaced to anonymize or pseudonymize the biological-related information and the generated information stored in the storage device, and to perform the usage-authorization control processing such that only the analysis data is used for performance evaluation or improvement of the generative information processing model or a related information processing model.

### Application Example 1

### (Supplementary 1)

A system comprising a processor,
wherein the processor is configured to
receive biological information including genetic information from a user, convert the received biological information into feature data for analysis,
estimate one or more indicators related to a health condition based on the feature data by using a statistical learning model,
acquire supplementary information including cost information related to health resources, examination items, nutritional support resources, or medical products,
generate a prompt sentence for a generative AI model based on the indicators related to the health condition and the supplementary information including the cost information,
cause the generative AI model, by inputting the prompt sentence, to generate information including a natural-language explanatory content and a proposal for optimization of health-related expenditure,
convert the explanatory content and the proposal for optimization of health-related expenditure into provision information in a format capable of being output to a user terminal and provide the provision information to the user terminal, and
store the biological information, the indicators related to the health condition, the prompt sentence, and the provision information in a storage device and manage the stored data by performing access control and encryption.

### (Supplementary 2)

The system according to supplementary 1,
wherein the processor is configured to
evaluate cost-effectiveness of the health-related expenditure by associating the indicators related to the health condition with the supplementary information including price information and effect information regarding the health resources, examination items, nutritional support resources, or medical products, and to include a result of the evaluation in the prompt sentence so that the generative AI model generates a proposal for health-related expenditure having high cost-effectiveness.

### (Supplementary 3)

The system according to supplementary 1,
wherein the processor is configured to
receive instruction information and feedback information from the user, reconstruct the prompt sentence based on the instruction information, the feedback information, the indicators related to the health condition, and previously generated explanatory content, and cause the generative AI model to regenerate an alternative proposal or a modified proposal for optimization of health-related expenditure according to changed conditions.

### EXAMPLE 2

### (Supplementary 1)

A system comprising a processor,
wherein the processor is configured to
receive biological information from a user and store the biological information in a storage area,
acquire research information automatically from one or more information sources via a communication network and store the research information in the storage area,
perform preprocessing on the research information by using natural language processing to extract information elements indicating target factors, treatment contents, and outcome contents from the research information,
generate a prompt sentence including an analysis request for a generative information processing apparatus based on the biological information and the research information, input the prompt sentence and the research information into the generative information processing apparatus, and obtain an analysis result from the generative information processing apparatus,
compare information elements relating to the target factors included in the analysis result with the biological information and extract or aggregate useful information corresponding to the biological information,
generate a prompt sentence requesting creation of user-oriented explanatory information for the generative information processing apparatus based on the useful information and obtain non-expert user-oriented explanatory information from the generative information processing apparatus,
transmit the non-expert user-oriented explanatory information to a user terminal so that the user terminal presents the non-expert user-oriented explanatory information as notification information and display information, and
perform encryption processing and access control processing on the biological information and the research information to protect and manage the biological information and the research information.

### (Supplementary 2)

The system according to supplementary 1,
wherein the processor is configured to
generate search conditions, acquire document information from a plurality of document information providing devices by using the search conditions via the communication network as the research information, and register the acquired document information in the storage area as a target of the preprocessing by using the natural language processing.

### (Supplementary 3)

The system according to supplementary 1,
wherein the processor is configured to
generate structured data including the target factors, the treatment contents, and the outcome contents extracted from the research information, generate the prompt sentence for the generative information processing apparatus in a form including the structured data, and obtain the analysis result from the generative information processing apparatus in association with the structured data.

### Application Example 2

### (Supplementary 1)

A system comprising a processor,
wherein the processor is configured to
receive biological information from a user through an input interface,
encrypt the biological information and store the encrypted biological information in a storage, and decrypt the encrypted biological information from the storage to obtain the biological information,
acquire research information corresponding to the biological information from an external information source and perform a formatting process on the research information, generate a prompt sentence to be input to a generative AI model on the basis of the biological information and the research information,
transmit the prompt sentence to the generative AI model, and analyze response information obtained from the generative AI model to generate explanation information including treatment method information, risk information, and lifestyle proposal information, transmit the explanation information to a terminal device and provide the explanation information as display information,
receive emotion information representing an emotional state of the user acquired by the terminal device, and adjust contents of the prompt sentence and an expression style of the explanation information on the basis of the emotion information,
select a health-related product or a health-related service on the basis of the explanation information, present a selection result to the terminal device, and generate transaction information for an electronic settlement process, and
encrypt the biological information, the explanation information, and the transaction information, control access to encrypted information on the basis of access authority, and perform backup and restoration of the encrypted information.

### (Supplementary 2)

The system according to supplementary 1,
wherein the processor is configured to
receive, as the emotion information, a result of emotion recognition processing using image information and audio information, and, when the emotion recognition processing determines that the user is in an anxious state or a high-stress state, add a request for providing reassuring explanation to the prompt sentence and adjust the explanation information so as to suppress presentation of high-load risk information and present the risk information stepwise.

### (Supplementary 3)

The system according to supplementary 1,
wherein the processor is configured to
include product information or service information related to the treatment method information, the risk information, and the lifestyle proposal information contained in the explanation information in the prompt sentence to the generative AI model so that recommendation candidate information is generated, select the product information or the service information on the basis of the recommendation candidate information, and provide guidance for an electronic settlement process and security warning information to the user through the terminal device.

What is claimed is:

1. A system comprising:
circuitry configured to:
receive, via a communication interface coupled to a packet-switched network, structured biological data from a terminal device, normalize and validate the structured biological data, and obtain attribute data from a storage device to append to the normalized biological data;
select a prompt template from a plurality of templates stored in the storage device based on rule evaluation over the normalized biological data and the attribute data, generate a prompt sentence by substituting data fields into placeholders of the selected prompt template, and input the prompt sentence to a generative neural network model to produce generated information;
apply text-processing algorithms to the generated information to extract structured output comprising risk assessment data, candidate procedure data, and guidance candidate data, and combine the structured output with the attribute data using conditional rules to produce individualized information;
transmit the individualized information as visualization-structured data to the terminal device via the communication interface;
encrypt the structured biological data, the prompt sentence, the generated information, and the individualized information and store the encrypted data in the storage device with access-authorization control; and
generate anonymized analysis data from the stored encrypted data by removing or replacing identification fields, and use the anonymized analysis data to perform parameter adjustment of the generative neural network model.

2. The system of claim 1, wherein the circuitry is configured to represent the structured biological data as records with predefined fields including a biological identifier field, a variant descriptor field, a classification field, and a measurement field, and to enforce record format validation before generating the prompt sentence.

3. The system of claim 2, wherein the circuitry is configured to represent the attribute data as records in a user profile table linked to a user identifier, the attribute data comprising normalized codes for demographic items and clinical history flags.

4. The system of claim 3, wherein the circuitry is configured to apply rule-based selection over the classification field of the structured biological data and the demographic items of the attribute data to select a template from templates associated with predefined risk categories.

5. The system of claim 4, wherein the circuitry is configured to generate the prompt sentence by replacing placeholders in the selected template with values from the normalized biological data and the attribute data, and to control model generation parameters including output token count, sampling temperature, and top-k sampling thresholds based on a type of requested output.

6. The system of claim 1, wherein the generative neural network model is a transformer-based sequence model comprising multiple attention layers and feed-forward layers, and the circuitry is configured to apply beam search decoding with output constraints that enforce inclusion of predefined concept tokens and restrict excluded term classes.

7. The system of claim 6, wherein the circuitry is configured to apply decoding constraints algorithmically by maintaining an inclusion list and an exclusion list that modify next-token probability distributions before sampling.

8. The system of claim 1, wherein the text-processing algorithms segment the generated information into logical sections by scanning for heading patterns and key-phrase patterns, and map detected phrases to structured labels in the risk assessment data, the candidate procedure data, and the guidance candidate data using a rule-based classifier.

9. The system of claim 8, wherein the circuitry is configured to combine the structured output with the attribute data by applying conditional rules that adjust recommendation parameters based on attribute values, and to cache structured recommendations for predefined combinations of classification category and attribute range to reduce repeated model invocations.

10. The system of claim 1, wherein the circuitry is configured to generate follow-up prompt sentences by embedding follow-up query text from the terminal device together with the stored structured biological data and prior generated information, and to input the follow-up prompt sentences to the generative neural network model to produce supplemental individualized information.

11. The system of claim 10, wherein the circuitry is configured to store follow-up query sequences and associated supplemental generated information as session records in the storage device and use the session records to construct extended context for subsequent follow-up prompt sentences.

12. The system of claim 1, wherein the encryption processing applies symmetric-key encryption to individual data fields before writing to the storage device, and decryption keys are managed by a key management component separate from application logic.

13. The system of claim 12, wherein the access-authorization control applies role-based access policies that permit read operations on encrypted records only to authorized requestors, and the circuitry is configured to audit access attempts and store audit records in the storage device.

14. The system of claim 1, wherein generating the anonymized analysis data comprises replacing identification fields with pseudonymous tokens computed by a deterministic one-way function and verifying that no re-identification path exists before using the anonymized analysis data for parameter adjustment.

15. The system of claim 14, wherein the parameter adjustment comprises constructing training batches from the anonymized analysis data, computing a loss function between model outputs and reference outputs, and updating model weights using an iterative gradient-based optimization algorithm.

16. The system of claim 1, wherein the visualization-structured data comprises a risk summary section, a procedure recommendation list, and a guidance list formatted for dashboard-type presentation on the terminal device, and the circuitry is configured to update the visualization-structured data upon each new individualized information generation event.

17. The system of claim 1, wherein the circuitry is configured to invoke a related information processing model to perform auxiliary risk scoring on the structured biological data before generating the prompt sentence, and to embed the auxiliary risk score as an additional field in the prompt sentence to condition the generative neural network model output.

18. A system comprising:
circuitry configured to:
receive, via a communication interface coupled to a packet-switched network, structured biological data from a terminal device, normalize the structured biological data into records with predefined classification fields, and obtain attribute data from a storage device;
select a prompt template from a plurality of templates stored in the storage device by applying rule evaluation over the classification fields and the attribute data, generate a prompt sentence by substituting biological data field values and attribute values into template placeholders, and input the prompt sentence to a transformer-based generative neural network model with controlled sampling temperature and output token count;
apply beam search decoding with constraint lists that enforce concept inclusion and term exclusion, and extract risk assessment data, candidate procedure data, and guidance candidate data from model output by scanning for key-phrase patterns using text-processing algorithms;
combine the extracted data with the attribute data using conditional rules, cache structured results for predefined classification-attribute combinations, and transmit individualized information as visualization-structured data to the terminal device;
apply symmetric-key field-level encryption to the structured biological data, the prompt sentence, and the individualized information and store encrypted records with access-authorization control; and
generate anonymized analysis data by replacing identification fields with pseudonymous tokens and use the anonymized analysis data to update model weights via iterative gradient-based parameter adjustment.

19. The system of claim 18, wherein the circuitry is configured to generate follow-up prompt sentences by embedding follow-up query text from the terminal device with stored structured biological data and prior generated information, input the follow-up prompt sentences to the transformer-based generative neural network model, and store resulting supplemental generated information as session records in the storage device.

20. A method comprising:
receiving, via a communication interface coupled to a packet-switched network, structured biological data from a terminal device, normalizing and validating the structured biological data, and obtaining attribute data from a storage device;
selecting a prompt template from a plurality of templates stored in the storage device based on rule evaluation over the normalized biological data and the attribute data, generating a prompt sentence by substituting data fields into placeholders of the selected template, and inputting the prompt sentence to a generative neural network model to produce generated information;
applying text-processing algorithms to the generated information to extract risk assessment data, candidate procedure data, and guidance candidate data, and combining the extracted data with the attribute data to produce individualized information;
transmitting the individualized information as visualization-structured data to the terminal device via the communication interface;
encrypting and storing the structured biological data, the prompt sentence, the generated information, and the individualized information with access-authorization control; and
generating anonymized analysis data from the stored data and using the anonymized analysis data to perform parameter adjustment of the generative neural network model.
